(19) United States
(12) Patent Application Publication
(10) Pub. No.: US 2026/0099328 A1
(43) Pub. Date: Apr. 9, 2026

(54) COMPUTER-IMPLEMENTED METHOD AND COMPUTER SYSTEM FOR SOFTWARE MODERNIZATION

(71) Applicant: Accenture Global Solutions Limited, Dublin (IE)

(72) Inventors: Sherin VARGHESE, Bangalore (IN); Arun Vidyadharan, Bangalore (IN); Priyanka Yadav, Lucknow (IN); Akshay Ravindra, Bangalore (IN); Vijeth Srinivas Hegde, Bangalore (IN); Koushik M Vijayaraghavan, Chennai (IN)

(73) Assignee: Accenture Global Solutions Limited, Dublin (IE)

(21) Appl. No.: 18/908,147

(22) Filed: Oct. 7, 2024

(51) Int. Cl. G06F 8/76

(52) U.S. Cl. CPC G06F 8/76

(57) ABSTRACT

Methods, systems, and computer-readable storage media for converting legacy software into modern software. The legacy software and any supporting content for conversion is received. Content types and software categories are determined based on the legacy software and the supporting content. Further, actions to be taken for the software categories are identified and foundation models are selected based on the content types and the actions, to support the conversion. For each of the actions to convert the legacy software into the modern software, a sequence of steps is generated. Further, a check is performed to determine if any necessary software to execute the sequence of steps for each of the actions is missing. If any necessary software is missing, a replacement software is generated for the missing software. Further, the sequence of steps for each of the actions is executed to generate the modern software.

### TECHNICAL FIELD

Various embodiments described herein relate generally to computer-implemented method and computer system for converting legacy software into modern software.

### BACKGROUND

Mainframe devices are computers used primarily by large organizations for critical applications, bulk data processing, enterprise resource planning, transaction processing, and/or the like. Mainframe devices are being phased out by large organizations and being replaced with distributed devices, cloud computing platforms, and/or the like. At such times, it is not possible to retrofit legacy software being executed on the mainframe devices to support new hardware features of the distributed devices, cloud computing platforms, and/or the like. Due to which there exists a need for converting the legacy software into modern software, which can support the new hardware features. The legacy software is converted into the modern software with main phases such as discover, assess, and prioritize.

### SUMMARY

Implementations of the present disclosure are generally directed to conversion of legacy software into modern software by expediting and optimizing phases of the conversion using semantics-driven process distribution with multi-model techniques.

In general, innovative aspects of the subject matter described in this specification provide a computer-implemented method for converting legacy software into modern software. The method includes receiving the legacy software and any supporting content for conversion. The method includes first identifying content types within the legacy software and supporting content. The method includes first determining one or more software categorizes for the legacy software and the supporting content. The method includes second identifying actions to be taken for identified software categories. Based on the identified content types and the identified actions, the method includes first selecting foundation models to support the conversion. The method includes first generating a sequence of steps for each of the actions to convert the legacy software into the modern software. The steps include steps for the selected foundation models, corresponding prompts for the selected foundation models to apply during the steps, and non-foundation model steps. The method includes second determining if any necessary software to execute the steps is missing. In response to a positive result of the second determining, the method includes second generating replacement software for the missing software and executing the sequence of steps to generate the modern software.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE FIGURES

Various embodiments in accordance with the present disclosure will be described with reference to the drawings, in which:

FIG. 1 depicts an example environment that may be used to execute implementations of the present disclosure.

FIG. 2 depicts an example architecture of a conversion system for converting legacy software into modern software, in accordance with implementations of the present disclosure.

FIG. 3 depicts a conceptual architecture of a conversion manger in the conversion system, in accordance with implementations of the present disclosure.

FIG. 4 is a block diagram depicting components of the conversion manager, in accordance with implementations of the present disclosure.

FIG. 5 depicts an example illustration of identifying actions for software categories of the legacy software, in accordance with implementations of the present disclosure.

FIG. 6 depicts an exemplary illustration of selecting foundation models for content types of the legacy software, in accordance with implementations of the present disclosure.

FIGS. 7A and 7B depict exemplary illustrations of generating a template including sequence of steps, in accordance with implementations of the present disclosure.

FIG. 8 depicts an example illustration of generating prompts for foundation model steps, in accordance with implementations of the present disclosure.

FIG. 9 depicts an example illustration of updating templates in global and local template repositories, in accordance with implementations of the present disclosure.

FIG. 10 depicts an example illustration of generating quality metrics for foundation model steps in the templates, in accordance with implementations of the present disclosure.

FIG. 11 depicts an example illustration of an execution pre-processing phase, in accordance with implementations of the present disclosure.

FIG. 12 depicts an example illustration of selecting a chunking methodology for performing chunking of data of the legacy software, in accordance with implementation of the present disclosure.

FIGS. 13A, 13B, 13C, and 13D depict an example illustration of scheduling an execution framework for execution of template/sequence of steps for each of actions to be taken for converting the legacy software into the modern software, in accordance with implementations of the present disclosure.

FIG. 13E depicts another example illustration of scheduling the execution framework including assigning the foundation models for the foundation model steps based on hosting infrastructures of the foundation models, in accordance with implementation of the present disclosure.

FIGS. 14A, 14B, and 14C depict exemplary illustrations of performing chunking of data of the legacy software into the multiple chunks and processing of the multiple chunks, in accordance with implementations of the present disclosure.

FIG. 14D depicts an example illustration of generating a refined summary from the processing of the multiple chunks, in accordance with implementations of the present disclosure.

FIG. 15 depicts an example illustration of allocating actions to the templates/sequence of steps and executing the sequence of steps using worker pods, in accordance with implementations of the present disclosure.

FIG. 16 depicts an example illustration of controlling execution of the sequence of steps including the foundation model steps, in accordance with implementations of the present disclosure.

FIG. 17 depicts an example illustration of performing retry, rephrase, and regenerate (RRR) functions, in accordance with implementations of the present disclosure.

FIG. 18 depicts an example illustration of generating graphs for results of the execution of the templates for the actions, in accordance with implementations of the present disclosure.

FIG. 19 depicts an example illustration of creating a collaborative platform, in accordance with implementations of the present disclosure.

FIG. 20 depicts an example illustration of user interactions with the conversion system through Retrieval Augmented Generation (RAG) Artificial Intelligence (AI) framework, in accordance with implementations of the present disclosure.

FIG. 21 is a flow diagram that presents an example computer-implemented method for converting the legacy software into the modern software, in accordance with implementations of the present disclosure.

FIG. 22 depicts an example illustration of an application architecture of the conversion system, in accordance with implementations of the present disclosure.

FIGS. 23A-23G and 24A-24B depict exemplary illustrations of providing multi-modal responses for requests, in accordance with embodiments of the present disclosure.

FIG. 25 depicts an example illustration of a page of the collaborative platform, in accordance with implementations of the present disclosure.

FIG. 26 illustrates a computer system that may be used to implement the method for converting the legacy software into the modern software, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Legacy language” and the like refers to an outdated software language that has fallen out of mainstream/mainframe computing device use, such as Common Business Oriented Language (COBOL), Programming Language Named for Blaise Pascal (PASCAL), Cold Fusion, etc.

“Legacy software” and the like refers to aged software/application that is either no longer operable on current platforms, has limited operability on current platforms or other impediments that limits its use on current platforms or mainframe devices, and/or for which upgrades are either not available or cost effective. An example would be a program that will not work on an upgraded operating system and the original developer will not provide an upgrade, such as a program written in a legacy language. Factors of legacy software could be: aging talent-lack of subject matter experts and developers on (legacy) skills of the applications; lack of adequate documentation or missing documentation; delayed maintenance and evolution of code base, where stakeholders reluctant to take actions due to lack of content for informed decision making; monolithic and complex code base, where it is an expensive proposition to get rare skills onboard to go through the massively monolithic application code line by line and prepare detailed documentation and detailed diagrams.

“Modern software” and the like refers to software/application created by converting the legacy software using one or more embodiments herein. Modern software is compatible with current platforms, speeds, and processing requirements.

Use of legacy software presents continuing technical problems because either the legacy software is no longer usable, reliable, and secure, or standard commercial upgrades are not available to the legacy software due to advances in the design of computer hardware. Traditional methods would be to purchase entirely new software packages, which sacrifices legacy data and may not provide the same functionality as the legacy software, or have programmers create new customer software from scratch, which is expensive, time consuming, and will present new scalability issues when those programmers leave the company and subject matter experts are no longer available for maintenance and upgrades.

Therefore, there exists a need for a scalable solution that can support modernization of legacy software/application. Modernization involves converting the legacy software into modern software by involving three phases, such as, discover, assess, and prioritize. The discover, assess, and prioritize phases involve:
Retain: Retain involves prioritizing the legacy software that is crucial for organization's operations and stacking the prioritized legacy software before migration and modernization.
Retire: Retire involves removing other legacy software which is not prioritized.
Rehost: Rehost involves moving the legacy software and associated operating system and databases onto a conversion platform making no changes to code or programming language (hereinafter referred to as legacy language) associated with the legacy software.
Re-platform: Re-platform involves containerizing the legacy software without changing the legacy language, re-compiling the legacy language to run on a modernized computing device/system, and performing minor changes to the legacy software.
Rearchitect: Rearchitect involves digital decoupling, rearchitecting, and rewriting the legacy software using cloud architectures and accordingly transforming the legacy software to the modern software using migration toolkits. Further, rearchitect involves enabling higher usage of cloud native services for modernization of the legacy software.
Replace: Replace involves implementing the modern software as a packaged solution to replace the existing legacy software and extracting and migrating data related to the modern software on a new system.
Reimagine: Reimagine involves building and customizing solutions for adoption of the modern software.

However, traditional methods involve manual effort to convert the legacy software into the modern software. Due to which, organizations face multiple challenges:
Aging talent: Lack of skills exhibited by Subject Matter Experts (SMEs) and programmers on the legacy software.
Lack of adequate document or missing documentation.
Delayed maintenance and evolution of code base: The organizations reluctant to perform any actions due to lack of content for informed decision making.
Modernization incurs more time and expense, as modernization of the legacy software takes several months.
Monolithic and complex code base: Expensive proposition is required for obtaining rare skills onboard to analyze through the massive monolithic application code of the legacy software line by line and for preparing detailed documentation and detailed diagrams.
Retain, retire, rehost, re-platform, rearchitect, replace, and reimagine processes of the three phases are performed with high risk for mission critical legacy software.
Regular updates and upgrades to the legacy software are required for changing the legacy software, improving its security, and running operations of the organization effectively.

Due to the above-described challenges, the organization is hindered from modernizing the legacy software at speed, handling production incidents within Service Lease Agreements (SLAs), enhancing existing legacy software, migrating the legacy software to more secure and latest hardware platforms/cloud computing platforms, scaling up the operations of the organization, and improving security measures.

Further, to overcome the challenges that may incur at the three phases of modernization, traditional methods enable purchasing of the modern software entirely for the legacy software. However, the modern software sacrifices legacy data of the legacy software and accordingly does not provide the same functionality as the legacy software. Further, programmers/developers or SMEs are required to create the modern software from a scratch. Therefore, the traditional methods are expensive, time consuming and present new scalability issues when the programmers and SMEs are no longer available for maintenance and upgrades.

Implementations of the present disclosure enable efficient conversion of the legacy software into the modern software by scaling up the three phases (discovery, assess and prioritize) with reduced time, expenses, and manual efforts.

During a discover phase, implementations of the present disclosure dissect the legacy software by delving into documents, source code, architecture diagrams, video/audio recordings detailing requirements discussion and deciphering a design of the legacy software. During an assess phase, implementations of the present disclosure excavate a communication between integrated files/modules of the legacy software to unravel an underlying mechanism of how the architecture of the legacy software and interdependencies of the files look like. Accordingly, actions to be taken for converting the legacy software into the modern software are identified and further templates are generated for the respective actions. Each of the templates include a sequence of steps for a respective action. During a prioritize phase, implementations of the present disclosure schedule an execution framework by ordering the actions and the associated templates and prioritizing foundation models for the templates. Thereafter, the templates are executed for the respective actions in accordance with the scheduled execution framework, which results in generation of the modern software for the legacy software. Therefore, implementations of the present disclosure enable generation of the modern software for the legacy software without re-inventing/writing the entire legacy software from a scratch.

Implementations of the present disclosure further use gained insights from the discover phase to downstream results of execution of the templates/actions, which ensures compatibility with evolving technical, potential security threats in the modules of the legacy software, interoperability, software improvements and adaptation.

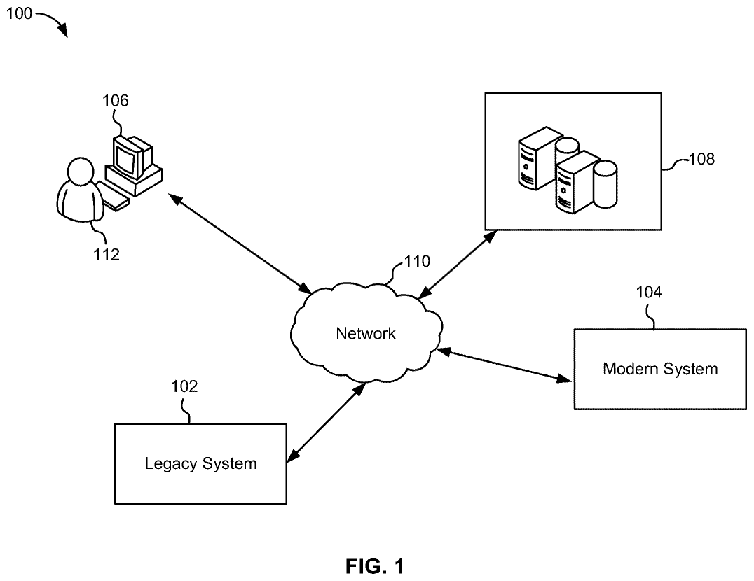

FIG. 1 depicts an example environment 100 that may be used to execute implementations of the present disclosure. In some examples, the example environment 100 manages conversion of legacy software into modern software.

As depicted in FIG. 1, the example environment 100 includes a legacy system 102, a modern system 104, a client device 106, and a conversion system 108. For simplicity, a single legacy system, a single modern system, a single client device, and a single conversion system 108 are depicted in FIG. 1, however, the example environment 100 may include one or more legacy systems, one or more modern systems, one or more client devices, and one or more conversion systems. The components 102-108 of the example environment 100 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The legacy system 102 may be associated with an entity, which requires to replace the legacy system 102 with the modern system 104. Replacing the legacy system 102 with the modern system 104 may refer to converting the legacy software being executed on the legacy system 102 into a modern software for execution on the modern system 104. Examples of the entity associated with the legacy system 102 may include, an organization, a corporation, a business unit of a corporation, a department of a corporation, a government agency, a banking unit, and/or the like. A non-limiting example of the legacy system 102 may include a mainframe device. The legacy system 102 may include a hardware platform with hardware components and a programmed computer (not depicted in FIG. 1). The hardware platforms may be controlled by the programmed computer. The programmed computer may execute the legacy software. The legacy software may refer to aged or outdated software (also be referred to as legacy application, legacy code, and/or the like), which is either no longer operable on the legacy system 102 or for which upgrades are either not available or cost effective. In some examples, the legacy software/application may be used for bulk data processing, entity/enterprise resource planning, transaction processing, and/or the like.

The modern system 104 may have improved hardware design compared to the legacy system 102. Examples of the modern system 104 may include, but are not limited to, a cloud computing system, a distributed server system, and/or the like. The modern system 104 may execute the modern software corresponding to the legacy software.

The client device 106 may be used by a respective user 112 to log into and interact with computing platforms executing software conversion applications. Examples of the client device 106 may include a desktop computing device, a smartphone, a laptop, tablet, a voice-enabled device, and/or the like. It is contemplated that implementations of the present disclosure may be realized with any appropriate type of computing device. In some examples, the client device 106 may display one or more Graphical User Interfaces (GUIs) that enable the user 112 to interact with the computing platform executing the software conversion applications. Interacting with the computing platform may include identifying the legacy software to be converted into the modern software for execution on the modern system 104.

In some examples, the conversion system 108 may be implemented as an on-premises system that is operated by an enterprise or a third-party engaged in cross-platform interactions and software conversion management. In some examples, the conversion system 108 may be implemented as an off-premises system (for example, cloud or on-demand) that is operated by an enterprise or a third-party on behalf of an enterprise. In some examples, the conversion system 108 may be implemented in a cloud environment. For simplicity, the conversion system 108 depicted in FIG. 1 may be a cloud environment that is intended to represent various forms of servers including a web server, an application server, a proxy server, a network server, a server pool, and/or the like. In some examples, the conversion system 108 hosts the software conversion applications, which may be executed on the computing platforms for identifying the legacy software for conversion.

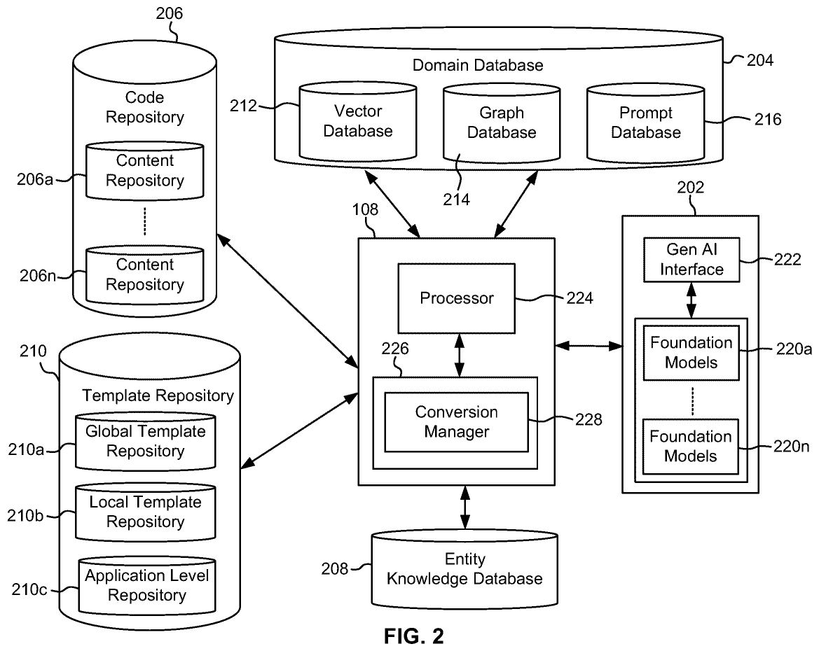

In accordance with implementations of the present disclosure, the conversion system 108 converts the legacy software into the modern software. The modern software may provide functionality of the legacy software and may be operated entirely on the modern system 104. Various examples of converting the legacy software into the modern software are described in detail in conjunction with FIGS. 2-26.

FIG. 2 depicts an example architecture of the conversion system 108 for converting the legacy software into the modern software, in accordance with implementations of the present disclosure. As depicted in FIG. 2, the conversion system 108 may be communicatively coupled to a Generative Artificial Intelligence (GAI) system 202, and various repositories such as, a domain database 204, a code repository 206, an entity knowledge database 208, and a template repository 210. The GAI system 202 and the various repositories 204-210 may be accessed by the conversion system 108 for converting the legacy software into the modern software.

The GAI system 202 includes foundation models 220a-220n. In some examples, the foundation models 220a-220n may be hosted on a same hosting infrastructure. In some other examples, the foundation models 220a-220n may be hosted on different hosting infrastructures. An example of the hosting infrastructure may include a cloud computing platform or the like. Further, the foundation models 220a-220n may be hosted in different types of paradigms, which include, without limitation, model-as-a service (MaaS) models, specialized MaaS (SMaaS) models, self-deployed models, and/or the like.

The foundation models 220a-220n may be described as general-purpose GAI models like large deep learning neural networks. For example, the foundation models 220a-220n may include Large Language Models (LLMs), which are a form of GAI that may be used to generate text for a variety of use cases. In some examples, the LLMs may be integrated in digital assistants (for example, chatbots), replacing traditional rule-based systems to provide textual responses to an input. The LLMs may generate human-like text and perform various Natural Language Processing (NLP) tasks (for example, translation, question-answering, and/or the like). In some examples, the LLMs refer to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like. For another example, the foundation models 220a-220n may include vision language models. The vision language models may learn simultaneously from images and texts to perform many tasks from visual question answering to image captioning. Therefore, the foundation models 220a-220n may include multi-modal models that learn from images and text.

The GAI system 202 further includes a GAI/Gen AI interface 222 for interacting with the foundation models 220a-220n of the GAI system 202. The foundation models 220a-220n may provide various GAI services including, but not limited to, text generation, embedding generation, image generation, audio generation, video generation, and/or the like.

While implementations of the present disclosure are described in further detail herein with non-limiting reference to the foundation models 220a-220n, it is contemplated that implementations of the present disclosure may be realized using any Machine Learning (ML) models, or Artificial Intelligence (AI) models, or any other similar models.

The code repository 206 include content repositories 206a-206n. Each of the content repositories 206a-206n may store the legacy software and supporting content. In some examples, the user associated with the client device 106 may upload the legacy software in a excel format or as a form. The legacy software may include multiple files (also be referred to as codes, modules, or the like). In some examples, the files may include code files, audio files, image files, summary code files, and/or the like. Each of the code files may include multiple line of codes (LOC). In some examples, the supporting content may include a domain, Key Performance Indicators (KPIs), processes/operations, and/or the like, associated with the legacy software.

The entity knowledge database 208 acts as a repository for storing a metadata, a category-action mapping, a content type-model mapping, a step-metric mapping, and/or the like. In some examples, the entity knowledge database 208 may be regularly updated from the template repository 210 along with the metadata. The metadata may include successful conversion information/stories and process management levels.

In some examples, the successful conversion information may include benchmark reports related to successful conversion of the legacy software into the modern software (hereinafter referred to as conversion), a client technology stack, outcomes generated from the conversion, templates and the foundation models 220a-220n used for the conversion, volume of the conversion, an accuracy of the conversion, time consumed for per LOC conversion, and/or the like. The templates (also be referred to as patterns) may indicate a sequence of steps executed for the conversion.

In some examples, the process management levels may be defined by the entity associated with the legacy system 102. The process management levels may indicate phases for the conversion. Examples of the phases may include discover, assess, prioritize, and/or the like.

In some examples, the category-action mapping may include mappings of software categories of the legacy software and associated actions (also be referred to tasks, use-cases, and/or the like). Therefore, the category-action mapping may indicate the actions appropriate for each of the software categories of the legacy software. The software categories may include a legacy language code, an infrastructure as code, a user interface code, and/or images. The actions may include code translation, test case generation, the conversion, security enhancement, agile methodology, microservices execution, and/or the like.

In some examples, the content type-model mapping may include mappings of content types of the legacy software and the associated foundation models 220a-220n. Therefore, the content type-model mapping may indicate the suitable foundation model for each of the content types. The content types may include a code (also be referred to as software code, application code, or the like), images, non-software text, dependency files, word documents, presentation files, Portable Document Format (PDF) files, and/or the like.

In some examples, the step-metric mapping may include steps and associated quality metrics. Therefore, the step-metric mapping may indicate the suitable quality metric(s) for evaluation of the respective step. The steps may be generated for the conversion and executed using the foundation models 220a-220n.

The template repository 210 includes a global template repository 210a, a local template repository 210b, and an application-level repository 210c. The global template repository 210a may store the templates generated by different conversion systems including the conversion system 108. The templates may be generated for the respective actions to be performed for converting the legacy software into the modern software. Each of the templates may include a sequence of steps. The local template repository 210b may include the templates generated by the conversion system 108 for the conversion. The local template repository 210b may regularly push the templates to the global template repository 210a. The templates stored in the global and local template repositories 210a-210b may be designed to cater to the different actions depending on user requirements and are non-exhaustive. Therefore, the templates act as a primary source for dynamically executing the actions on the various files/modules of the legacy software according to the user requirements. The application-level repository 210c may include the template selected for the conversion.

The domain database 204 includes a vector database 212, a graph database 214, and a prompt database 216.

The vector database 212 stores information as vectors. The vectors (also be referred to as vector embeddings) may be numerical representation of the information. In implementations disclosed herein, the information may include prompts/requests generated for the foundation models 220a-220n and responses generated using the foundation models 220a-220n for the prompts/requests. The responses may indicate results execution of the sequence of steps/templates. The graph database 214 stores one or more graphs generated based on the results of execution of the sequence of steps/templates. The prompt database 216 stores the prompts generated for the foundation models 220a-220n. It should be noted that storing information in the domain database 204 may refer to storing the information in any of the vector database 212, the graph database 214, and the prompt database 216. The information herein may include the prompts, the results of execution, and/or the like.

Still referring to FIG. 2, the conversion system 108 includes a processor 224, and a memory 226. The conversion system 108 may also include other components such as communication interfaces, Input/Output (I/O) devices, and so on (not depicted in FIG. 2).

In some examples, the processor 224 may include one or more processors. Examples of the processor 224 may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 224 may be programmed to cooperate with computer-readable instructions stored in the memory 226 (also referred to be as computer-readable medium) for performing operations according to the present disclosure. The memory 226 may be non-transitory or non-volatile medium, such as a magnetic disk or solid-state non-volatile memory or volatile medium such as Random Access Memory (RAM), and/or the like.

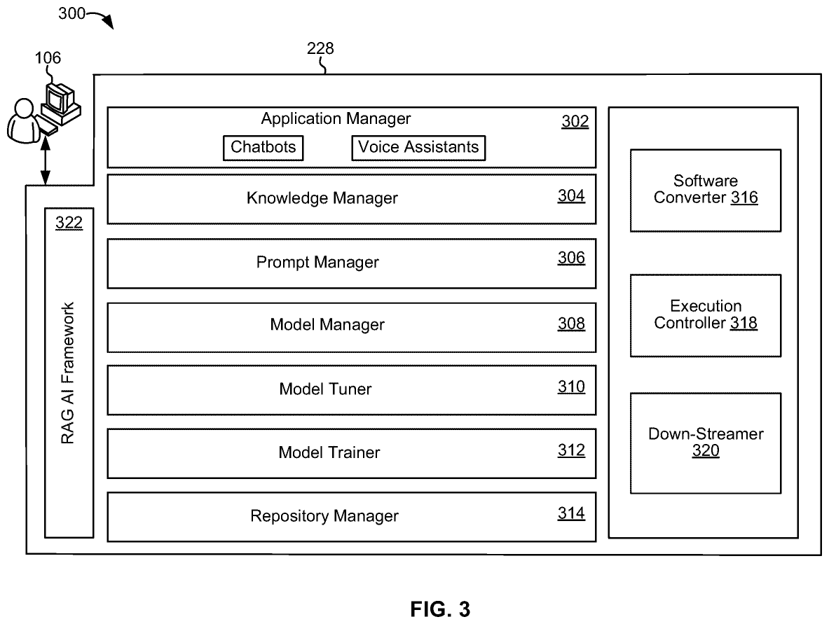

The conversion system 108 further includes a conversion manager 228 as depicted in FIG. 2. The conversion manager 228 may be stored in the memory 226 and provided as a downloadable library including the computer-readable instructions. The conversion manager 228 may be executed on the processor 224 for converting the legacy software into the modern software. A conceptual architecture 300 of the conversion manager 228 is depicted in FIG. 3.

As depicted in FIG. 3, the conceptual architecture 300 of the conversion manager 228 may be representative of multi-layered, and end-to-end framework, which is described in detail below. The conceptual architecture 300 of the conversion manager 228 includes an application manager 302, a knowledge manager 304, a prompt manager 306, a model manager 308, a model tuner 310, a model trainer 312, a repository manager 314, a software converter 316, an execution controller 318, a down-streamer 320, and a Retrieval Augmented Generation (RAG) AI framework 322.

The application manager 302 may include non-limiting example applications of chatbots, voice assistants, and/or the like, for receiving user input from the client device 106. The user input may indicate the legacy software to be converted. In some other examples, the application manager 302 may include a User Interface (UI) (e.g., a chatbot displayed in a Graphical User Interface (GUI)) or other user-accessible interface to enable the client device 106 to provide the user input.

The knowledge manager 304 may be described as a context setting layer that hosts an organizational knowledge as a searchable interface. For example, the prompts to the foundation models 220a-220n are augmented with domain data and/or organizational data through the knowledge manager 304.

The prompt manager 306 may include prompt development and management, and language modeling. The prompt manager 306 may provide the prompts that represent queries in an appropriate sequence to the foundation models 220a-220n. The prompt manager 306 may further connect with the vector database 212 and the graph database 214 to provide, for example, domain-based context and other details to the foundation models 220a-220n, which enables the foundation models 220a-220n to correctly interpret the prompts and generate the responses.

The model manager 308 may enable access to the foundation models 220a-220n, which are pre-trained and offered as managed services by multiple third parties (vendors). Such foundation models 220a-220n may be described as off-the shelf models and accessed as a service (e.g., through respective Application Programming Interfaces (APIs)).

The model tuner 310 may include hyperparameter (HP) tuning, transfer learning, and regularization. The HP tuning may include tuning hyperparameters of the one or more foundation models 220a-220n based on instructions from the execution controller 318 (which is described in detail along with the execution controller 318). Examples of the hyperparameters may include top_p (nucleus sampling), top_k (Top-K sampling), temperature, and/or the like.

The model trainer 312 may train various models, used in the process of converting the legacy software into the modern software. The various models may be typically available as public models and may be downloadable and customized (e.g., in terms of training, re-training, and fine-tuning, or the like) by the model trainer 312. The various models may include first and second template generation models, a prompt generation model, a linear regression model, a recommendation model, a schema generation model, first and second query generation models, first and second sections generation models, a configuration generation model, a classification model, and/or the like. The various models may include one or more of: LLMs, AI models, ML models, and/or the like.

The repository manager 314 may enable the conversion manager 228 to access the various repositories 204-210, as depicted in FIG. 2.

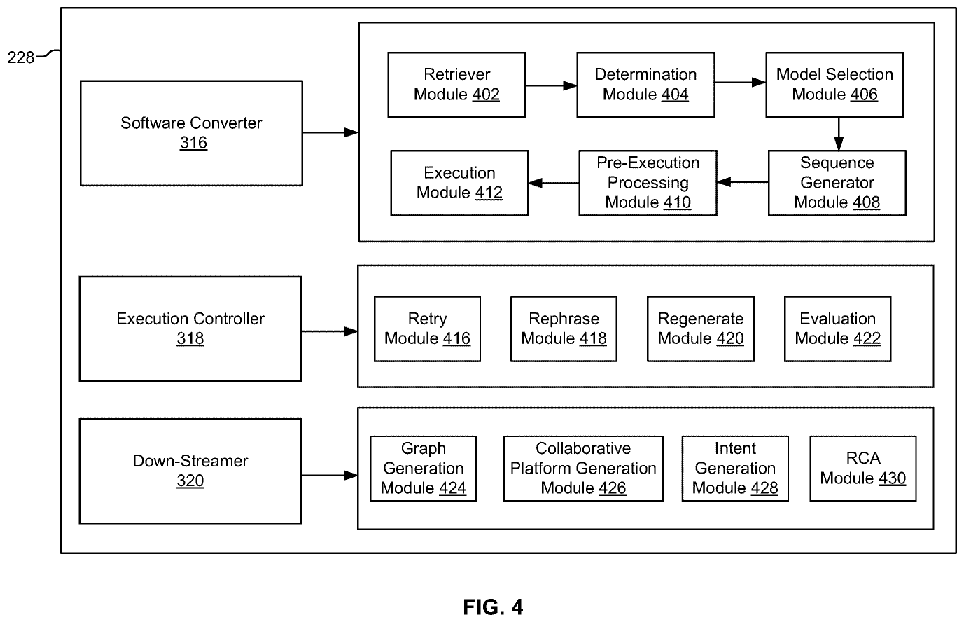

Still referring to FIG. 3, the conversion manager 228 includes a software converter 316, an execution controller 318, and a down-streamer 320, which are described in detail in conjunction with FIG. 4.

The software converter 316 converts the legacy software into the modern software. As depicted in FIG. 4, the software converter 316 includes a retriever module 402, a determination module 404, a model selection module 406, a sequence generator module 408, a pre-execution processing module 410, and an execution module 412.

The retriever module 402 receives the legacy software identified by the client device 106 for the conversion. The retriever module 402 may receive the legacy software from the content repositories 206a-206n of the code repository 206. In some examples, the received legacy software may be stored in the one or more content repositories 206a-206n as an excel or as a form. The legacy software may refer to an aged or outdated software/application. The legacy software may be built in a legacy language. The legacy language may refer to an outdated software language that has fallen out of mainstream/legacy system use. Examples of the legacy language may include, COBOL, PASCAL, Assembler, Job Control Language (JCL), old Java version, AngularJS, Uniface, and so on. The legacy software may include multiple files/codes (also be referred to as data or content of the legacy software). The multiple files may distributed/saved across the different content repositories 206a-206n of the code repository 206.

The retriever module 402 also receives any supporting content for the legacy software from the one or more content repositories 206a-206n of the code repository 206. In some examples, the supporting content may include a domain, Key Performance Indicators (KPIs), processes/operations, user manuals, and/or the like, associated with the legacy software.

The determination module 404 performs a first identification to identify the content types within the legacy software and the supporting content. In some examples, the content types may include a software/application code, images, non-software text, dependency files, word documents, presentation files, PDF files, excel workbooks, copybooks, and/or the like. In some examples, the content types may be augmented with SME inputs, external Application Programming Interface (API) content, and/or the like.

The determination module 404 may identify the content types by scanning the one or more content repositories 206a-206n of the code repository 206 depending on details such as Uniform Resource Locator (URL) of each of the content repositories 206a-206n, a branch, credentials, and so on. In some examples, the determination module 404 may perform the scanning of the one or more content repositories 206a-206n through DevOps pipeline using a suitable scanning method. For an example, the scanning method may include Static application security testing (SAST) method. Upon performing the scan, the determination module 404 may determine any security vulnerable issues associated with the legacy software and/or the supporting content. Therefore, any security vulnerable issues may be identified prior to implementation the conversion.

Once the content types are identified, the determination module 404 performs a first determination to determine the software categories for the legacy software and the supporting content. Examples of the software categories may include a legacy language code, an infrastructure as code, a user interface code, and/or images. For determining the software categories, the determination module 404 may receive user requirements from the client device 106. The user requirements may indicate the files/modules of the legacy software that the user decided to convert. Also, the user requirements may indicate the one or more templates selected by the user from the templates stored in the local template repository 210b. The determination module 404 may determine the software categorizes by scanning the received user requirements.

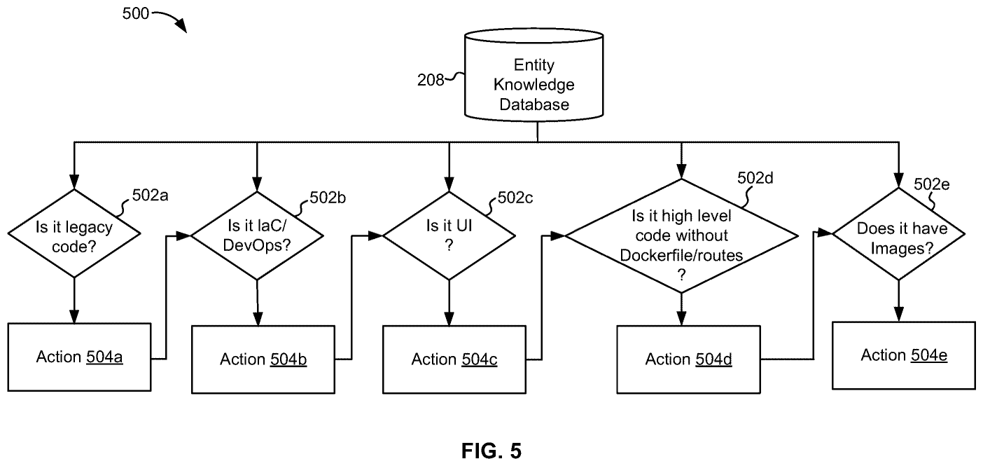

Upon determining the software categories, the determination module 404 performs a second identification to identify the actions to be taken for the determined software categories. Examples of the actions may include code translation, language understanding, test case generation, conversion, security enhancement, performing agile methodology, microservices execution, and/or the like. The determination module 404 may access the category-action mapping stored in the entity knowledge database 208. The determination module 404 may use the accessed category-action mapping to determine the actions corresponding to the respective software categories. An example illustration of identifying the actions for the respective software categories is described in detail in conjunction with FIG. 5. In some other examples, from the files of the legacy software and the supporting content, a user intent may be automatically detected. The user intent may indicate the actions to be performed for the legacy software. It should be noted that the identified content types, software categories and the supporting content of the legacy software may be used to understand software architecture layers, technical architecture layers and functional architecture layers of the legacy software.

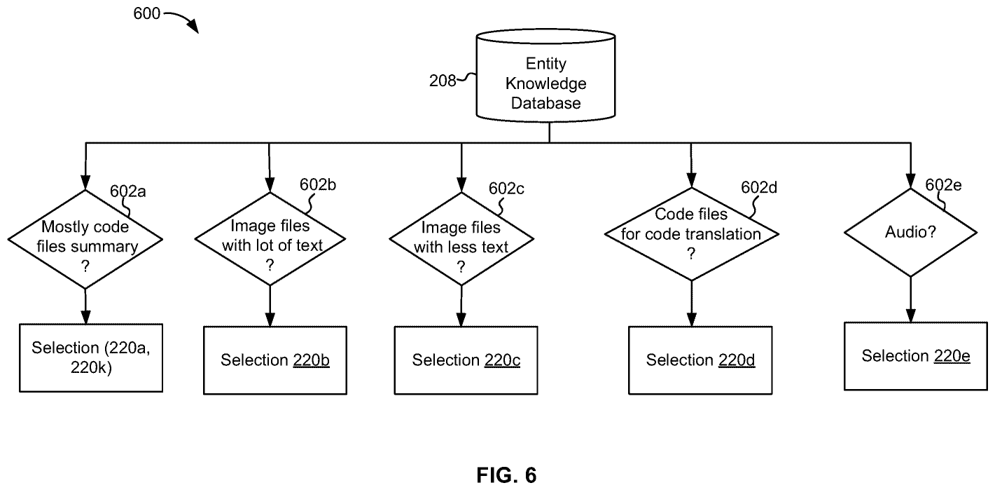

The model selection module 406 performs a first selection to select the foundation models 220a-220n for the content types identified for the legacy software. In some examples, the model selection module 406 may access the content type-model mapping from the entity knowledge database 208 and use the accessed content type-model mapping for selecting the foundation models 220a-220n for the respective content types. In some other examples, the model selection module 406 may select the foundation models 220a-220n based on one or more of: the content types, the actions identified for the legacy software, budget/time constraints, a summary of the content repositories 206a-206n, an availability of the foundation models 220a-220n, and/or the like. An exemplary illustration of selecting the foundation models 220a-220n is described in detail in conjunction with FIG. 6.

The sequence generator module 408 performs a first generation to generate the templates for the actions to be taken for converting the legacy software into the modern software. Each of the templates includes a sequence of steps. The sequence of steps includes foundation model steps and non-foundation model steps. The foundation model steps (also be referred to as prompt steps) may include steps to be executed using any of the selected foundation models 220a-220n. The foundation model steps may be accompanied with the prompts. Therefore, the foundation model steps may involve the foundation models 220a-220n and the associated prompts. The non-foundation model steps may be referred to as non-prompt steps in which the foundation models 220a-220n are not considered. Examples of the non-foundation model steps may include reading a file associated with the legacy software, adding line numbers to the code of the legacy software, and/or the like. The sequence of steps may be generated by generating the template(s).

In some implementations, for generating the template, the sequence generator module 408 may select a default template from the templates stored in the global template repository 210a for the non-foundation model steps. The sequence generator module 408 may further obtain the templates including an existing series of steps appropriate for the conversion from the global template repository 210a (hereinafter referred to as existing templates). Furthermore, the sequence generator module 408 may obtain the metadata including the process management levels and the successful conversion information from the entity knowledge database 208. The sequence generator module 408 may input the default template corresponding to the non-foundation steps, the existing templates, the metadata, and the actions as first template inputs to the first template generation model. The first template generation model may use the model trainer 312 (as depicted in FIG. 3) to train the first template generation model based on the first template inputs to generate the template. The first template generation model may be trained using few-shot learning examples (stored in the domain database 204). The trained first template generation model may be used to generate the template based on the first template inputs. The template may indicate the sequence of steps for the respective action.

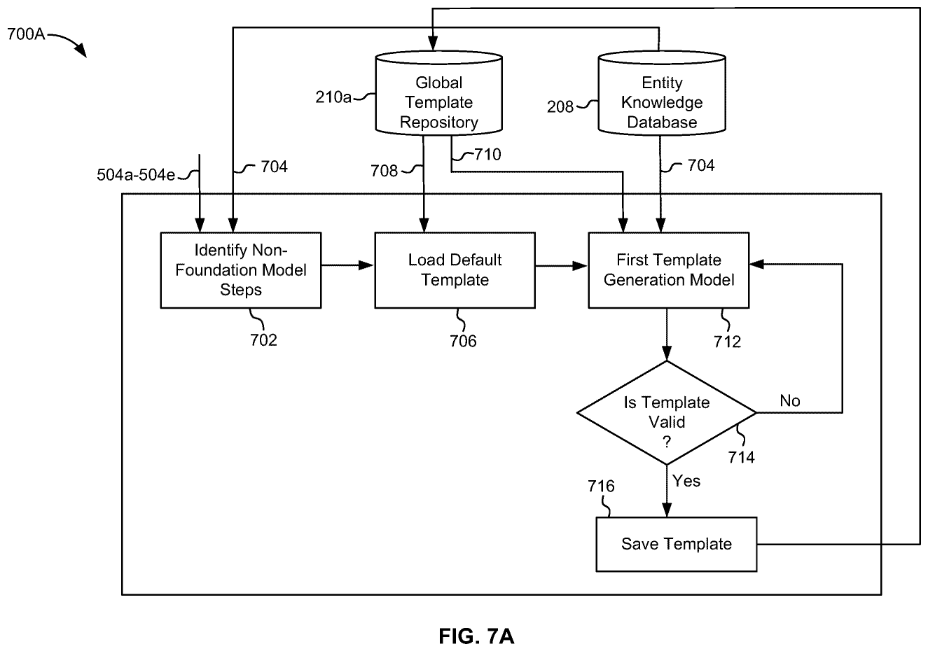

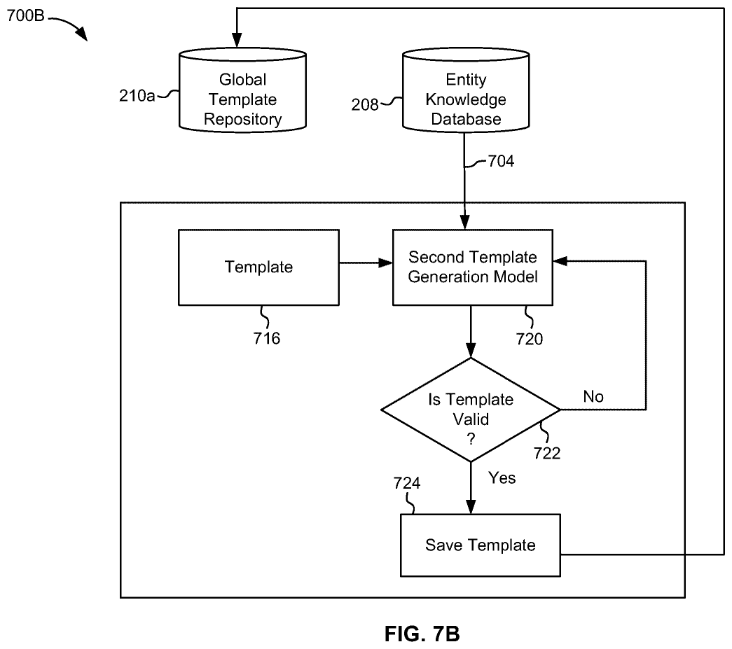

In some other implementations, the sequence generator module 408 may generate the template using the template generated by the first template generation model. The sequence generator module 408 may input the template generated using the first template generation model, the process management levels, and the actions as second template inputs to a second template generation model. The sequence generator module 408 may provide the second template inputs to the second template generation model using techniques such as Name Entity Recognition (NER), part-of-speech tagging (POS) tagging, and/or the like. Further, the sequence generator module 408 may use the model trainer 312 to train the second template generation model based on the second template inputs. The trained second template generation model may be used to generate the template. The template may indicate the sequence of templates for the respective action. Therefore, the sequence generator module 408 may use the first and second template generation models for generating the templates for the actions. For example, if actions 1, 2, and 3 are identified for converting the legacy software into the modern software, then templates T1, T2, and T3 are generated for the actions. Exemplary illustrations of generating the template/sequence of steps using the first and second template generation models are described in FIGS. 7A and 7B.

The pre-execution processing module 410 initiates an execution pre-processing phase/stage prior to execution of the selected template/sequence of steps for the conversion. During the pre-execution processing phase, the pre-execution processing module 410 performs execution pre-processing to generate prompts, a quality metric, and a replacement software (in case of missing software) for executing the templates corresponding to the actions. The pre-execution processing module 410 also schedules an execution framework to execute the templates corresponding to the actions.

The pre-execution processing module 410 generates the prompts and associated roles and parameters for execution of the foundation model steps in the sequence of steps. The prompts may include questions/requests appropriate for execution of the foundation model steps. The parameters may include the HPs. The roles may be used to guide responses of the foundation models while executing the foundation model steps. In some examples, the roles may include “system”, “user”, and “assistant”. The “system” may provide high-level instructions. The “user” may present queries or prompts. The “assistant” may be the responses of the foundation models. By differentiating the roles, context and conversation between the client device 106 and the conversion system 108 may be directed efficiently for execution of the foundation model steps. For example, if the client device 106 is required to generate successful conversion information/stories (e.g., user stories), a role of “scrum master” may be selected for executing the prompts for generation of the successful conversion information/stories.

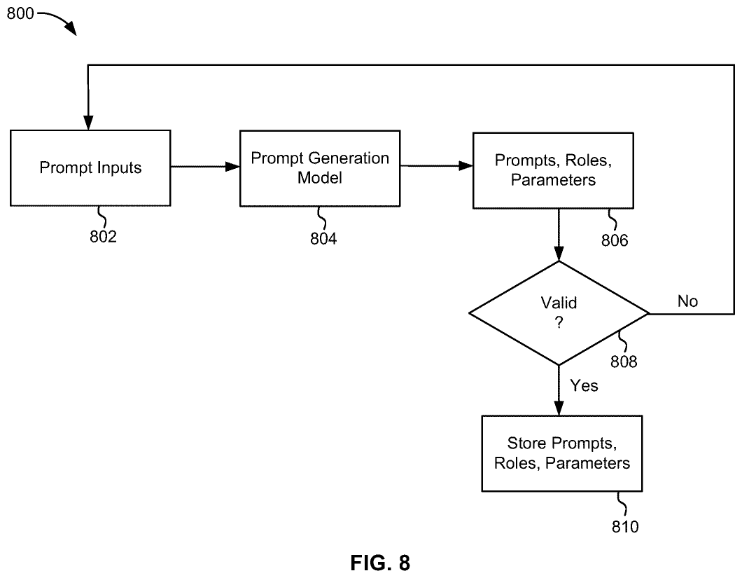

For generating the prompts and associated roles and parameters, the pre-execution processing module 410 may create prompt inputs. The prompt inputs may include the actions identified for the legacy software and the foundation model steps. The pre-execution processing module 410 may use the model trainer 312 to train the prompt generation model based on the prompt inputs. The pre-execution processing module 410 may use the trained prompt generation model to generate the prompts and the associated roles and parameters for the respective foundation models 220a-220n. The prompts and the associated roles and parameters may be stored in the vector database 212 as the vector embeddings. An exemplary illustration of generating the prompts is depicted in FIG. 8.

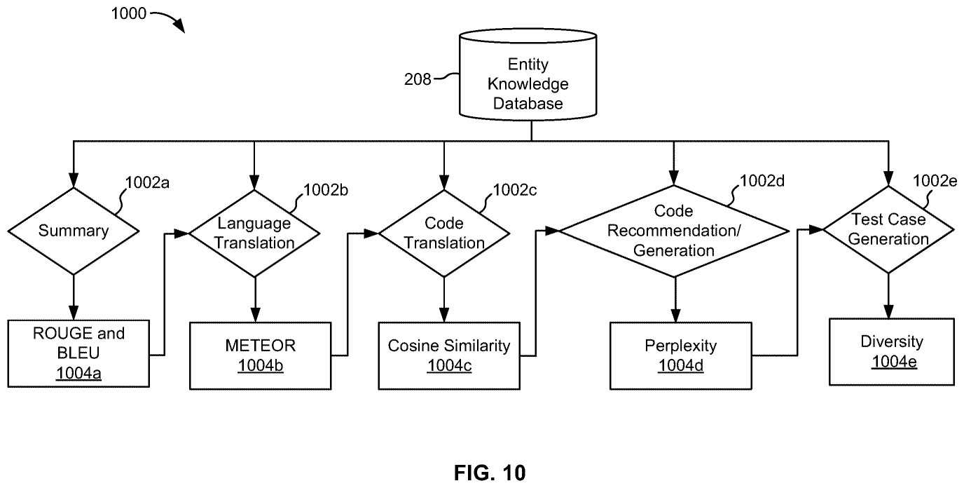

The pre-execution processing module 410 generates the one or more quality metrics for evaluating/measuring performance of execution of each of the foundation model steps included in each of the templates. Thereby, execution of each of the actions may be evaluated. In some examples, the pre-execution processing module 410 may access the step-metric mapping from the entity knowledge database 208 and use the accessed step-metric mapping to generate the one or more quality metrics for each foundation model step in the template. An exemplary illustration of generating the one or more quality metrics for each foundation model step is depicted in FIG. 10.

In some other examples, the pre-execution processing module 410 may create metric inputs. The metric inputs may include the template including sequence of steps generated for the conversion, the corresponding actions, and artifacts to be generated. The artifacts may include epics, features, conversion stories, and/or the like. The pre-execution processing module 410 may use the model trainer 312 to train the metric generation model based on the metric inputs. The pre-execution processing module 410 may use the trained metric generation model to generate the one or more quality metrics for each of the templates.

Further, the pre-execution processing module 410 performs a second determination to determine if any necessary software to execute the sequence of steps is missing. The necessary software may refer to additional APIs required for executing the sequence of steps. If the necessary software is missing for executing the sequence of steps, the pre-execution processing module 410 generates the replacement software for the missing software. The pre-execution processing module 410 may scan the replacement software through the DevOps pipeline for testing. Once the replacement software is tested successfully, the pre-execution processing module 410 may push the replacement software to a Network File System (not depicted in FIG. 4).

In addition, the pre-execution processing module 410 performs a third determination to determine whether the legacy software requires chunking. The pre-execution processing module 410 may perform the third determination based on the content types of the legacy software, a size of the prompts generated for the foundation models 220a-220n (referred hereinafter as a token size), the actions identified for the legacy software, input token limits of the foundation models 220a-220n (if the quality metric is required), and/or the like.

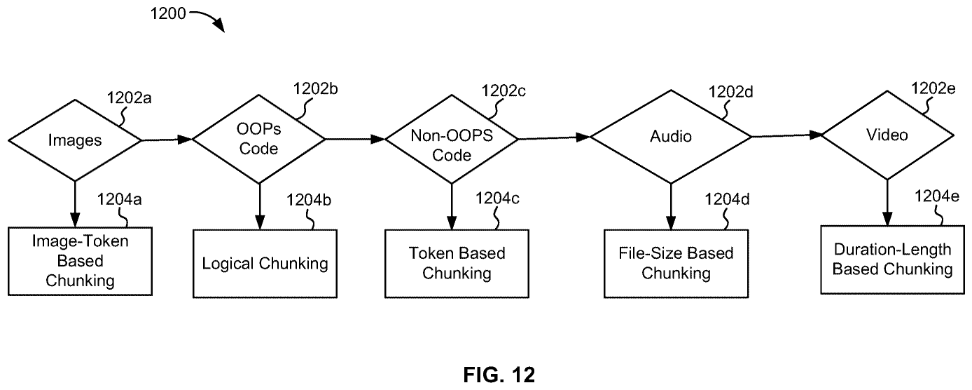

When it is determined that the legacy software requires chunking, the pre-execution processing module 410 performs a second selection to select one or more chunking methodologies appropriate for the legacy software. Examples of the chunking methodologies may include a logical chunking if the legacy software includes an object-oriented programming, a token-based chunking if the legacy software includes non-object oriented programming, file-size based chunking if the legacy software includes audio files, a duration-length based chunking if the legacy software includes video files, an image token based chunking if the legacy software includes image files. An example illustration of selecting the chunking methodology is described in detail in conjunction with FIG. 12.

In accordance with the selected one or more chunking methodologies, the pre-execution processing module 410 separates one or more files (also be referred to data, content, portions and/or the like) of the legacy software into chunks. Each of the chunks may be associated with each of the actions identified for converting the legacy software into the modern software. Therefore, on each of the chunks, the sequence of steps corresponding to the respective action may be performed.

After chunking the legacy software, the pre-execution processing module 410 schedules the execution framework for processing the chunks/actions. The execution framework may be scheduled by scheduling an order of the actions to be performed on worker pods, mapping the templates for the actions, determining cost and time parameters of the templates, and accordingly assigning the foundation models for the foundation model steps in each of the templates. The worker pods may provide appropriate resources (e.g., processors, containers, memory, Central Processing Units (CPUs), and/or the like) for executing the templates of the respective actions. In an example, the worker pods may be auto scalable.

In some examples, the pre-execution processing module 410 may analyze one or more of, a total number of steps in the sequence of steps, a number of foundation model steps among the total number of steps, a demography in which the foundation models 220a-220n are deployed, a number of chunks to be performed, using the linear regression model. Based on the analysis, the pre-execution processing module 410 may determine the cost and time parameters associated with each of the templates. Further, the pre-execution processing module 410 assigns the foundation models for the foundation model steps in each of the templates, while satisfying the determined cost and time parameters. The pre-execution processing module 410 may assign the foundation models from the selected foundation models 220a-220n for the conversion.

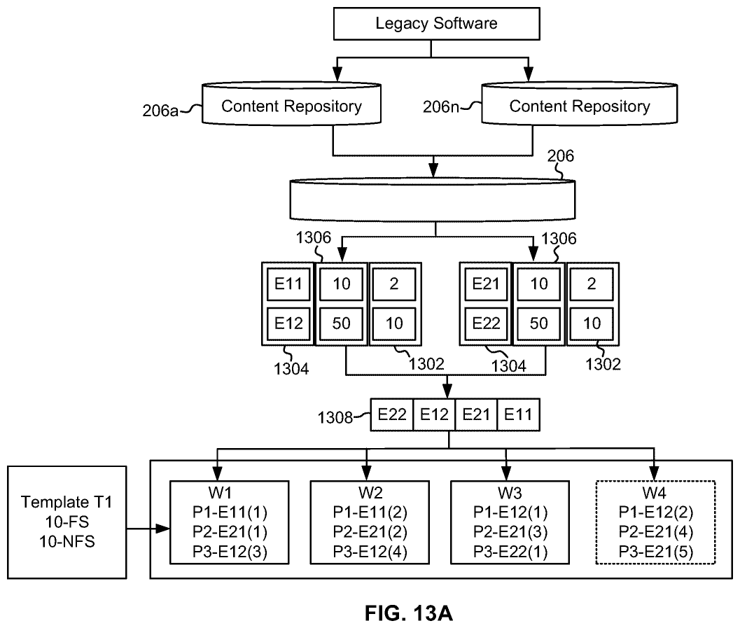

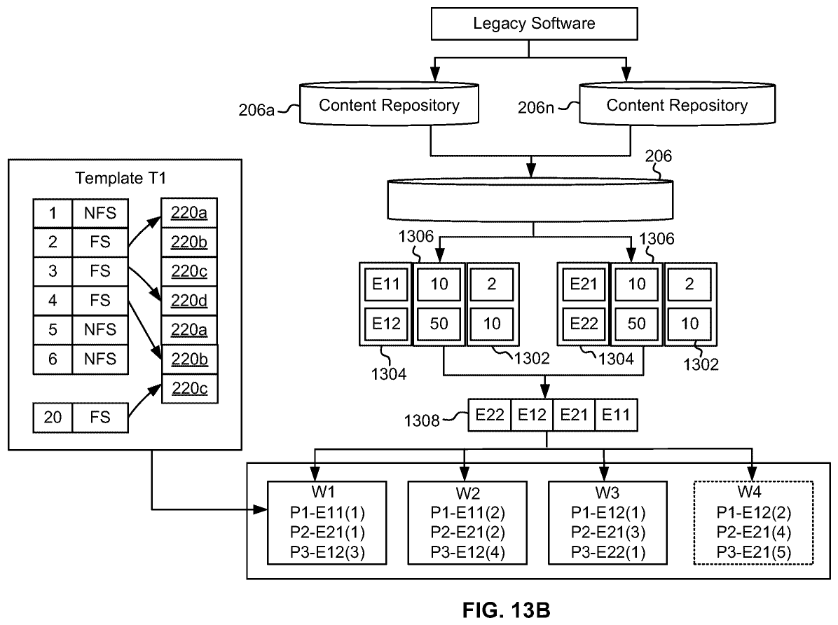

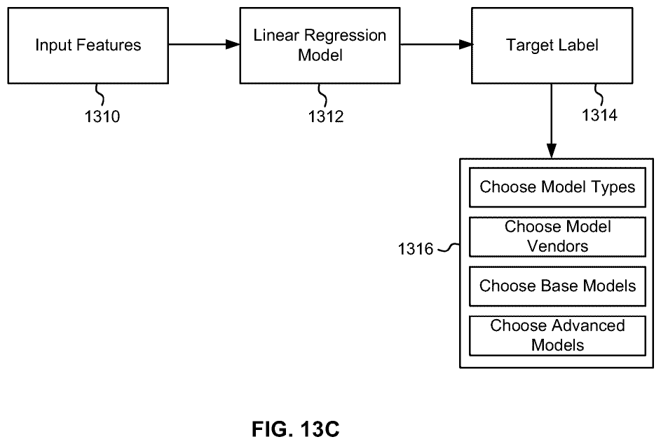

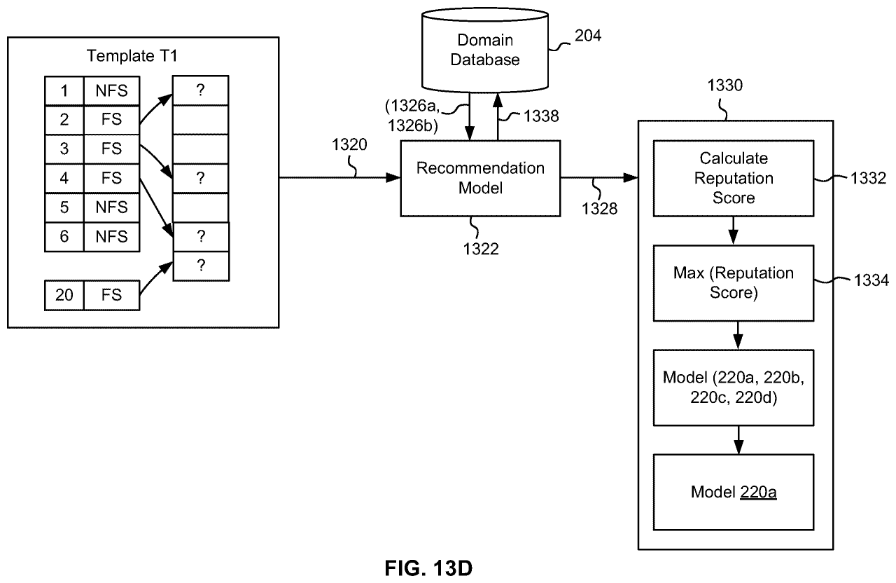

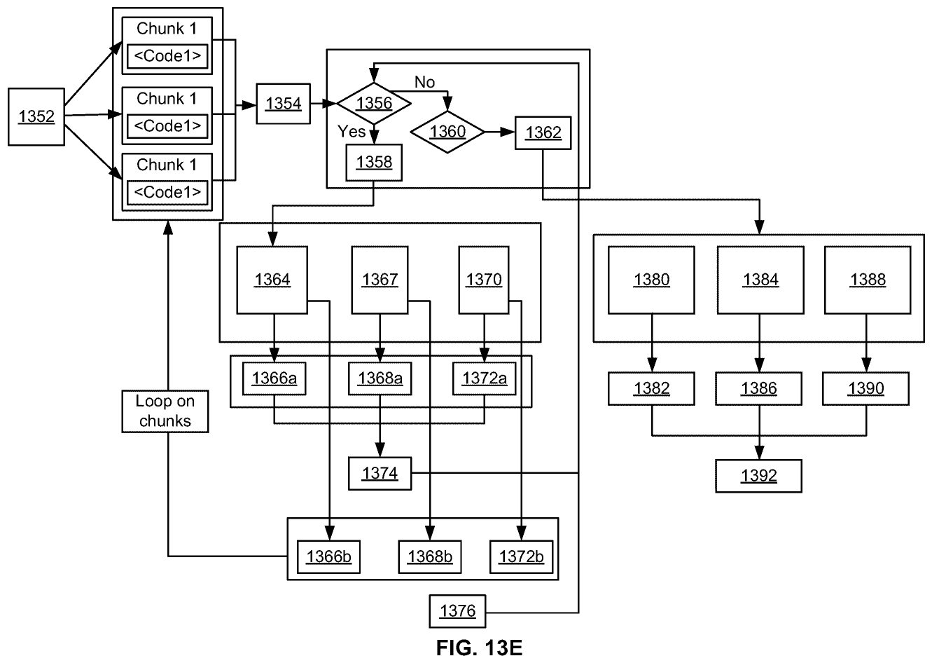

In some examples, the pre-execution processing module 410 may assign the foundation models by performing a trade-off between the selected foundation models 220a-220n with respect to the determined cost and time parameters of the respective template, which is described in detail in conjunction with FIG. 13C. In some other examples, the pre-execution processing module 410 may assign the foundation models based on a model reputation score of each of the selected foundation models 220a-220n and the action associated with the foundation model steps. The model reputation score may be calculated by comparing a resource utilization of each of the selected foundation models 220a-220n against overload of the worker pods (hereinafter referred as pod overload) and/or against the templates. The resource utilization may indicate a utilization of one or more Trusted Platform Modules of the hosting infrastructure/cloud computing platform for execution of the foundation models 220a-220n or Token Per Minute (TPM) of the foundation models 220a-220n. Each of the worker pods may include a collection of one or more containers for executing the foundation models 220a-220n. The pod overload may indicate CPU-memory limits, and creation of parallel threads and auto-scaler, for execution of the foundation model steps. The auto-scaler may include Horizontal Pod Autoscaler (HPA)/Vertical Pod Autoscaler (VPA). An example illustration of assigning the foundation models based on the model reputation score and the respective action is described in detail in conjunction with FIG. 13D.

If the determined cost/budget and time parameters for the templates are overshooting pre-defined budget and time constraints, the pre-execution processing module 410 prompts the user associated with the client device 106 to approve continuation of execution of the respective templates. If the user approved, the pre-execution processing module 410 validates the respective templates for further execution. If the user denies the templates, the pre-execution processing module 410 may indicate the sequence generator module 408 to generate new templates for the actions.

In some examples, the pre-execution processing module 410 also triggers and stores downstream jobs and observability flows in the domain database 204 (e.g., including the vector database 212, the graph database 214 (depicted in FIG. 2), NoSQL databases (not depicted in FIG. 4), or the like), which enable the down-streamer 320 to operate after the execution of the templates for the actions. Thereafter, the pre-execution processing module 410 may provide instructions to the execution module 412 for executing the templates for the actions, in accordance with the scheduled execution framework.

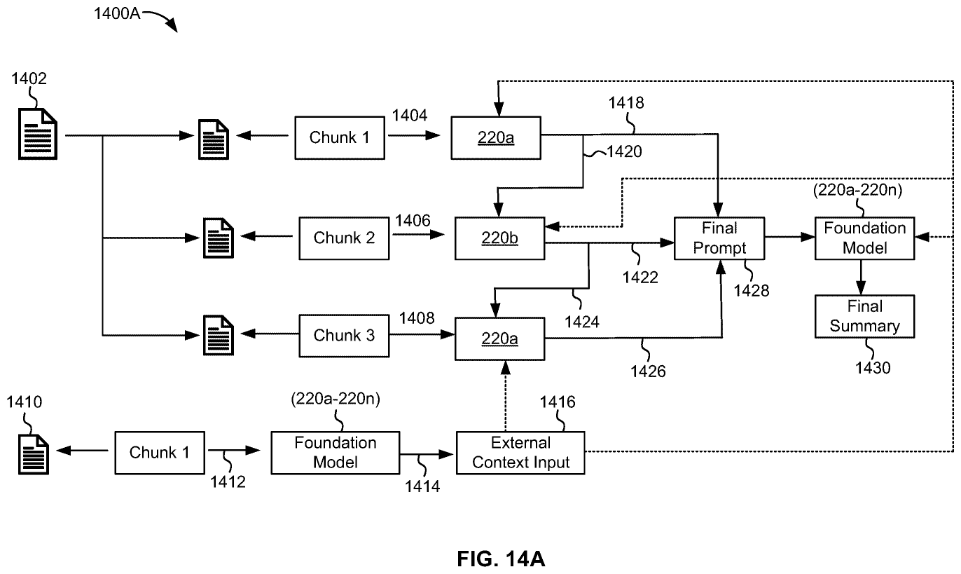

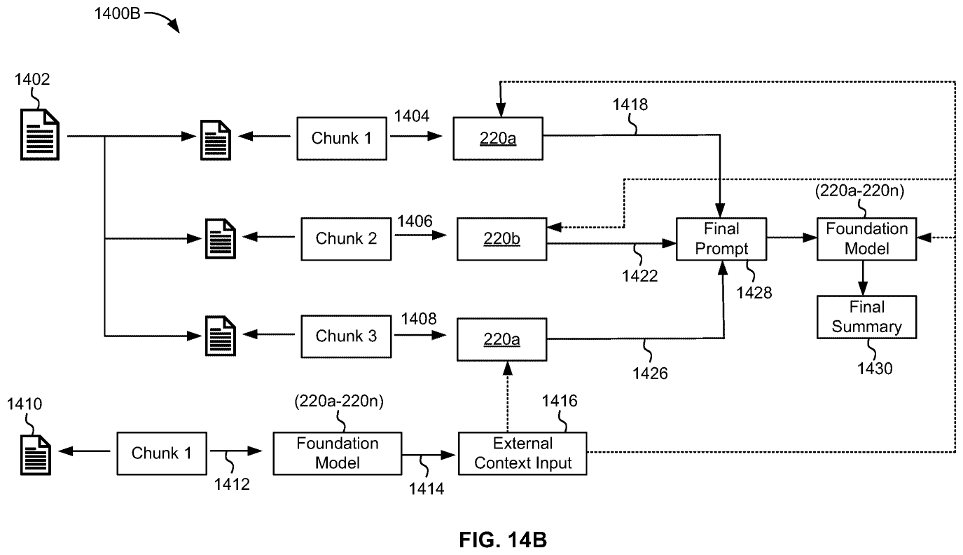

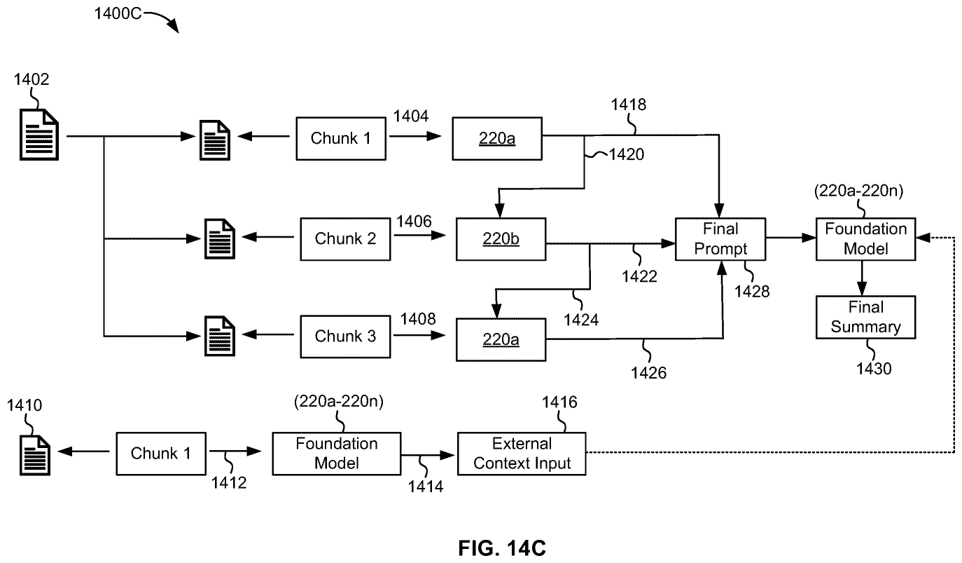

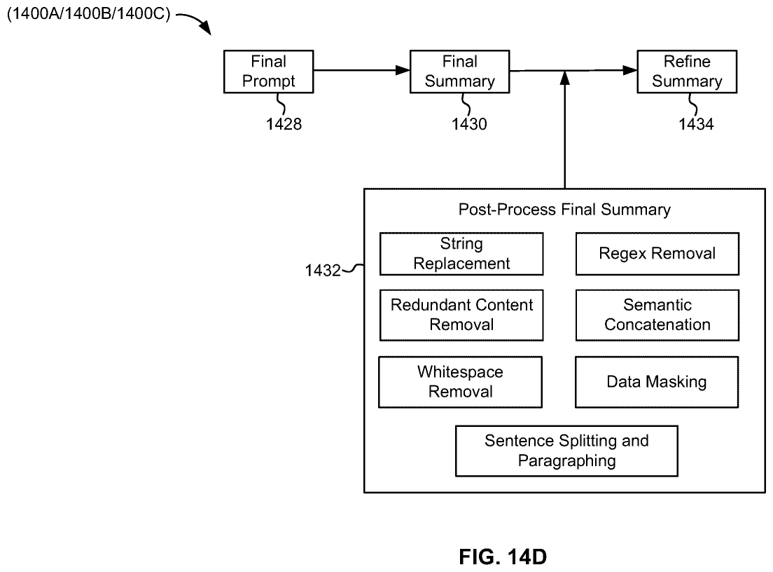

The execution module 412 executes the templates corresponding to the actions to generate the modern software corresponding to the legacy software. The execution module 412 may execute the templates in accordance with the execution framework scheduled by the pre-execution processing module 410. Executing the templates may refer to executing the sequence of actions of the templates on the respective chunks. Thereby, performing the actions on the respective chunks to generate the modern software for the legacy software. Further, exemplary illustrations of performing the chunking to divide the portions of the legacy software into the multiple chunks and executing each of the templates on the respective chunk using the assigned foundation models are described in detail in conjunction with FIGS. 14A-14D.

The execution module 412 further monitors results of execution of the sequence of steps and stores the monitored results in the domain database 204.

In some implementations, the execution controller 318 controls execution of the sequence of steps, for example, the foundation model steps in the sequence of steps. As depicted in FIG. 4, the execution controller 318 includes a retry module 416, a rephrase module 418, a regenerate module 420, and an evaluation module 422 for controlling execution of the foundation model steps.

The retry module 416 performs a quality check on the results of execution of the foundation model steps (included in the sequence of steps) with respect to the prompts generated for the execution of the respective foundation model steps. In an implementation herein, the retry module 416 may perform the quality check using the quality metrics generated for the respective foundation model steps. Based on the quality check, the retry module 416 derives quality scores for the results and compares the quality scores with a threshold score. In some examples, the threshold score may be pre-determined by the user. If the quality scores of the results of execution of the foundation model steps fall below the threshold score, the retry module 416 decides to tune (e.g., through the model trainer 312) the HPs of the foundation models assigned for execution of the respective foundation model steps. Further, the retuned foundation models are used to retry execution of the respective foundation model steps. The retry module 416 may iteratively perform the quality check and determination to tune the HPs of the foundation models (hereinafter referred to as retry function) until the quality scores of the results of execution of the respective foundation models fall equal to or above the threshold score or a number of retry counts reaches a pre-determined retry count. The number of retry counts may indicate how many times the retry function has been performed. The pre-determined retry count may indicate a maximum number of times the retry function may be performed. If the quality scores of the results of execution of the respective foundation models fall equal to or above the threshold score or the number of retry counts is equal to or greater than a pre-determined retry count, the retry module 416 enables the rephrase module 418 to operate.

The rephrase module 418 initiates rephrasing of the prompts (hereinafter referred to as rephrase function) for the foundation model steps corresponding to the results having the quality scores that fall below the score threshold. In some examples, the prompts may be rephrased by formatting structure of sentences, tones, tenses in the prompts. Once the prompts are rephrased, the rephrase module 418 may enable execution of the foundation model steps based on the rephrased prompts. Further, the results of execution of the foundation model steps may be evaluated by the retry module 416 for generation of the associated quality scores. If the quality scores of the results of execution of the foundation model steps still fall below the score threshold, the rephrase module 418 may continue the rephrase function until a number of rephrase counts reach a predetermined rephrase count or the quality scores of the results of execution of the foundation model steps fall equal to or above the threshold score. The number of rephrase counts may indicate a number of times the rephrase function has been performed. The pre-determined rephrase count may indicate a maximum number of times the rephrase function may be performed. Further, if the quality scores of the results of execution of the foundation model steps do not fall above the score threshold after reaching the pre-determined rephrase count, the regenerate module 420 may be enabled to operate.

The regenerate module 420 decides to initiate fine-tuning (hereinafter referred to as regenerate function) of the foundation models assigned for execution of the foundation model steps having the quality scores that fall below the score threshold. In some examples, the regenerate module 420 may provide instructions to the model tuner 310 (as depicted in FIG. 3) for fine-tuning the foundation models based on 1-n shot learning examples. The 1-n shot learning examples may be obtained from the entity knowledge database 208. Further, the 1-n shot learning examples may be associated with SME inputs. Upon fine-tuning the foundation models, the retry and rephrase functions may be iteratively performed by the retry and rephrase modules 416-418, till the quality scores of the results of execution of the foundation model steps fall above the score threshold. Therefore, by performing the retry, rephrase, and regenerate functions, hallucination that may incurred at the foundation models may be reduced.

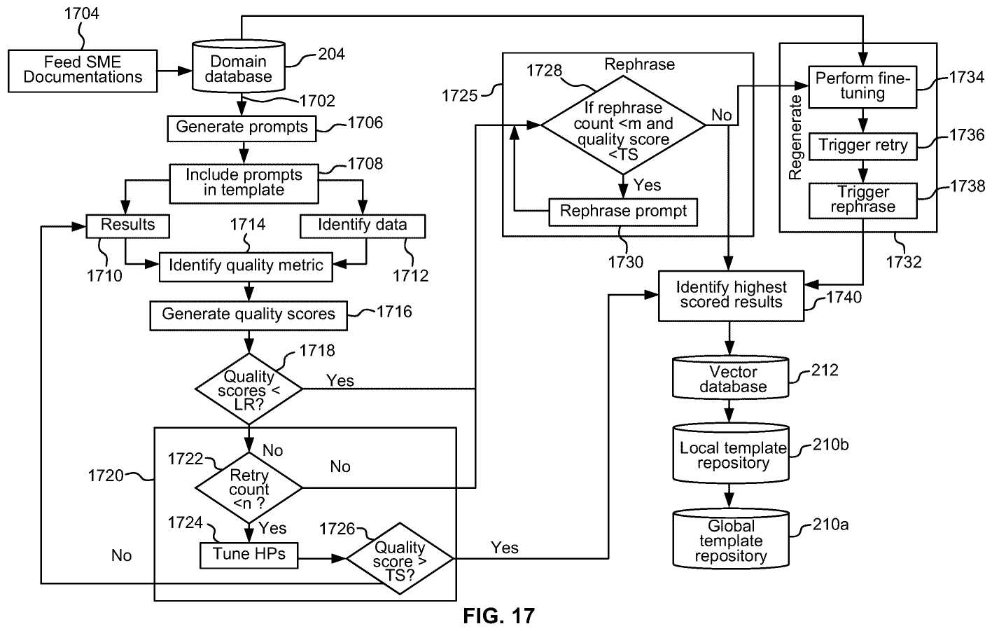

Further, when the quality scores of the results of execution of the foundation model steps fall above the score threshold, the evaluation module 422 identifies the result with the highest quality score among the results of execution of the foundation model steps. The evaluation module 422 identifies the foundation model step associated with the highest quality score and the prompt generated for execution of such a foundation model step. Further, the evaluation module 422 stores the prompt in the vector database 212 in the vector representation and also in the prompt database 216. An example illustration of performing the retry, rephrase, and regenerate functions is described in detail in conjunction with FIG. 17.

The down-streamer 320 performs visualizations of the results stored in the domain database 204. Th results may correspond to execution of the templates for the actions. As depicted in FIG. 4, the down-streamer 320 includes a graph generation module 424 and a collaborative platform generation module 426.

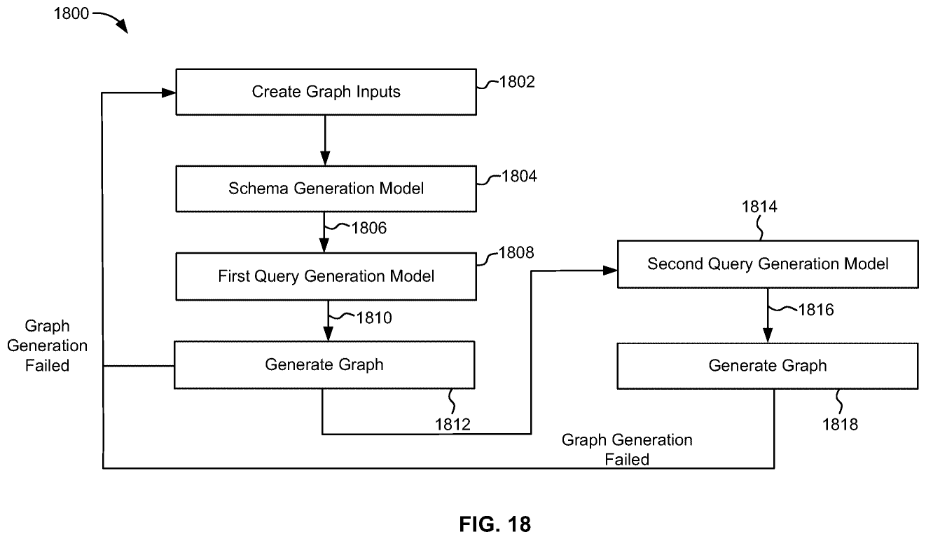

The graph generation module 424 creates graph(s) for the results of execution of the sequence of steps. The graph generation module 424 may analyze one or more of: the actions, the process management levels defined by the entity, the templates, and a summary of results, using the schema generation model and generate a schema. The graph generation module 424 analyzes the schema using the first graph generation model to create the graph. In some implementations, the graph generation module 424 further analyzes the created graph using the second graph generation model and creates the graph. Further, through the graphs, the conversion system 108 efficiently presents the agile artifacts such as, epics, features, user stories, and/or the like from the data (e.g., source code and documentation) of the legacy software. The graph may be stored in the graph database 214. An exemplary illustration of generating the graph may be described in detail in conjunction with FIG. 18.

The collaborative platform generation module 426 creates a collaborative platform for the results of execution of the sequence of steps. The collaborative platform may be used to provide information regarding the results of execution of the sequence of steps to the user associated with the client device 106. A non-limiting example of the collaborative platform may include wiki.

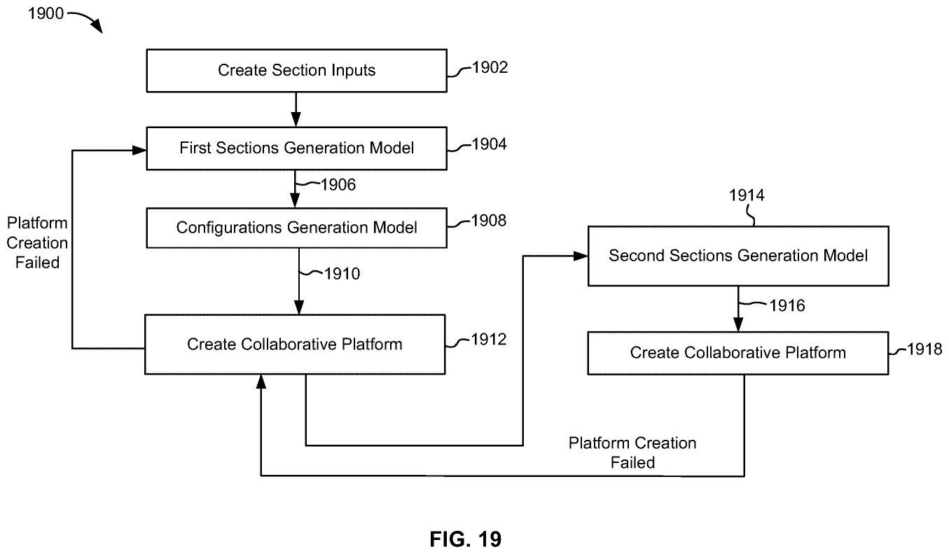

For creating the collaborative platform, the collaborative platform generation module 426 inputs the actions, the process management levels defined by the entity, and the template to the sections generation model and trains the sections generation model (through the model trainer 312 as depicted in FIG. 3) to generate sections. The sections may indicate platform pages corresponding to the different actions. Once the sections are generated, the collaborative platform generation module 426 may generate configurations for the sections. The collaborative platform generation module 426 may input the sections to the configuration generation model and train the configuration generation model (through the model trainer 312) based on the sections to generate the configurations for the sections. The collaborative platform generation module 426 may use the sections and the corresponding configurations to create the collaborative platform. An example illustration of creating the collaborative platform is described in detail in conjunction with FIG. 19.

Further, the down-streamer 320 operates in conjunction with the RAG AI framework 322 (as depicted in FIG. 3). The RAG AI framework 322 enables the user associated with the client device 106 to initiate a conversation with the conversion system 108 through the application manager 302 for accessing the results of execution of the templates for the actions. The conversation may include a request for retrieving the results corresponding to the actions. In such a scenario, the down-streamer 320 provides a recommendation to the RAG AI framework 322 to fetch the response for the request from the vector database 212 or the graph database 214 or the foundation model and to provide the fetched response to the user. The response may include the results of the requested actions.

The down-streamer 320 includes an intent generation module 428 for providing the recommendation to the RAG AI framework 322. The intent generation module 428 captures intents from the conversion. In some examples, the intent generation module 428 may capture the intents using the classification model. Further, depending on the actions and the intent, the intent generation module 428 generates the recommendation for the RAG AI framework 322 to fetch the response for the request from the vector database 212 or the graph database 214, or from the generic foundation module. For example, if the intent includes to retrieve the response in a text format, the intent generation module 428 may recommend the RAG AI framework 322 to fetch the result for the request from the vector database 212. If the intent includes to retrieve the response in a form of graphs, the intent generation module 428 may recommend the RAG AI framework 322 to fetch the result for the request from the graph database 214. The response may include the results of execution of the sequence of steps corresponding to the requested actions. If the results for the request are not found in the vector database 212 or the graph database 214, the intent generation module 428 may recommend the RAG AI framework 322 to generate the results for the request using any of the foundation models 220a-220n.

Still referring to FIG. 4, the down-streamer 320 includes a Root Cause Analysis (RCA) module 430. The RCA module 430 may perform a technical RCA and a rule/process RCA. The technical RCA may be performed to predict potential effects of code changes prior to implementation, which may further aid in identifying root causes for defects/bugs. The rule/process RCA may be performed to identify the entity knowledge database 208 hosting an incorrect process management levels/rules for executing the conversion.

Further, the RCA module 430 may identify incident identifier(s) (ID) from the conversation initiated between the client device 106 and the conversion system 108. The incident ID may indicate an issue(s) associated with the results (e.g., issue in the execution of the sequence of steps). Upon identifying the issues, the RCA module 430 identifies a root cause for the issue and recommends mitigation actions for mitigating the issue.

Therefore, the proposed conversion manager 228 automates the conversion of the legacy software into the modern software through creation of extensive documentation using the multi-models and through proper prioritization and micro-transformations. Due to which, the time and expense involved in the conversion is significantly reduced. Further, the proposed conversion manager 228 enables the user to access the results from the domain database 204 without any hassles.

For example, consider a scenario wherein the user associated with the client device 106 has a banking application (an example of the legacy software) built during last 50 years with highly complex architecture for execution on the legacy system 102. The banking application is built in a COBOL language and is a monolithic software. Therefore, the user faces frequent down-time and decides to modernize the legacy banking application with microservices-based architecture in Java (e.g., modern language). Further, the user does not have a required documentation about the legacy banking application and wants to understand the various functionalities and dependencies to effectively prioritize files/modules of the legacy banking application to be migrated and then initiate the modernization/conversion. In addition, the user has an outdated document that was written way back in 1967 and the user does not have skilled resources in understanding the legacy banking application and understanding the complex code of the legacy banking application consumes months together.

In such a scenario, the conversion manager 228 automates the conversion of the banking application into a modern banking application. The modern banking application may be in Java language. For the conversion, the conversion manager 228 identifies the supporting content, the content types, the software categories, and the actions for the banking application. The conversion manager 228 generates the templates for the actions. The conversion manager 228 executes the templates for the actions to generate the modern banking application. The foundation model steps of the templates are executed using the foundation models. Therefore, the modern banking application may be generated without requiring any skilled resources and with reduced expense and time. Further, the conversion manager 228 visualizes the results of execution of the templates in the graph and stores the graph in the graph database 214. In addition, the conversion manager 228 also creates the collaborative platform for accessing the results. Therefore, the user may gain insights to the results easily by accessing the graph database 214 or the collaborative platform.

FIG. 5 depicts an example illustration 500 of identifying the actions for the software categories of the legacy software, in accordance with implementations of the present disclosure. For converting the legacy software into the modern software, the conversion system 108 identifies the software categories within the legacy software and the associated supporting content. Upon identifying the software categories, the conversion system 108 accesses the category-action mapping from the entity knowledge database 208 for identifying the actions for the software categories of the legacy software.

As depicted in FIG. 5, if a software category includes a legacy language code 502a, the conversion system 108 identifies the actions 504a. The actions 504a may include one or more of: code translation, software/application modernization (e.g., the conversion), legacy software deployment on the modern system 104 through 7R strategy (e.g., Rehost, Retire, Refactor, Rearchitect, Re-platform, Retain, Replace), agile methodology/paradigm implementation, security enhancement, test cases generation, and/or the like. The actions 504a may also recommend patterns, which generate data dictionary, data models, computational logic, test cases, agile artifacts, and/or the like.

If the software category includes an infrastructure as code (IaC/DevOps) 502b, the conversion system 108 identifies the actions 504b. The actions 504b may include code translation, test cases generation, agile methodology implementation, security enhancement, HELM deployments, and/or the like.

If the software category includes a user interface (UI) code 502c, the conversion system 108 identifies the actions 504c. The actions 504c may include code translation to latest libraries/framework (e.g., from Angular to React), test cases generation, agile methodology implementations, and/or the like.

If the software category includes a high-level code without Dockerfile/routes 502d, the conversion system 108 identifies the actions 504d. The actions 504d may include microservices execution, software/application modernization, and/or the like.

If the software category includes images 502e, the conversion system 108 identifies the actions 504c. The actions 504e may include explanation of the legacy software, comparison of the legacy software/application with the given images, and/or the like.

FIG. 6 depicts an exemplary illustration 600 of selecting the foundation models 220a-220n for the content types of the legacy software, in accordance with implementations of the present disclosure. The conversion system 108 selects the foundation models 220a-220n for the conversion based on the content types of the legacy software. The conversion system 108 accesses the content type-model mapping from the entity knowledge database 208 for selecting the foundation models 220a-220n for the content types of the legacy software. Examples of the foundation models 220a-220n may include, Generative Pretrained Transformer-4 (GPT-4) models, Codex models, GCP Vision models, Azure GPT-Turbo Vision models, StarCoder models, Whisper models, and/or the like.

If a content type includes code files summary 602a, the conversion system 108 may select the foundation models such as, GPT-4 32K and Codex models 220a and 220k. If the content type includes images files with a lot of text 602b, the conversion system 108 may select the foundation models like GCP Vision models 220b. If the content type includes the image files with less text 602c, the conversion system 108 may select the foundation models like Azure GPT-Turbo Vision models 220c. If the content type includes code files for code translation 602d, the conversion system 108 may select the foundation models like StarCoder models 220d. If the content type includes audio 602e, the conversion system 108 may select the foundation models like Whisper models 220d.

FIG. 7A depicts an example illustration 700A of generating the template including the sequence of steps, in accordance with implementations of the present disclosure. The conversion system 108 generates the templates for the actions to be taken for converting the legacy software into the modern software. Each of the template may include sequence of steps for the respective action. The sequence of steps includes the foundation model steps and the non-foundation model steps. An example illustration of generating the template for one of the actions is depicted in FIG. 7A.

For generating the template for the action, the conversion system 108 identifies the non-foundation model steps 702. The conversion system 108 identifies the non-foundation model steps based on the respective action 504a-504e and the metadata 704 stored in the entity knowledge database 208. The metadata 704 may include the successful conversion information and the process management levels defined by the entity.

Once the non-foundation model steps 702 are identified, the conversion system 108 selects the default template 706 for the non-foundation model steps 702. The conversion system 108 receives existing default templates 708 from the global template repository 210a. The existing default templates 708 may correspond to templates associated with the non-foundation model steps 702. From the existing default templates 708, the conversion manager selects the appropriate/best suited default template 706 for the non-foundation model steps 702.

The conversion system 108 creates the first template inputs by including the default template 706, the existing templates 710 (accessed from the global template repository 210a), and the metadata 704 (accessed from the entity knowledge database 208). The existing templates 710 may include the existing series of steps appropriate for the conversion. The conversion system 108 calls the first template generation model 712 using the first template inputs to generate the template. The conversion system 108 performs a validation 714 to determine whether the generated template is valid or not. In some examples, the conversion system 108 may generate a basic testing DevOps pipeline with test scripts and perform the validation 714 using the generated basic testing DevOps pipeline. In some other examples, the conversion system 108 may communicate the generated template to the client device 106 for validation by the associated user.

If the generated template is not valid, the conversion system 108 repeats calling of the first template generation model 712 using the first template inputs for generating the template that is valid. If the generated template is valid, the conversion system 108 saves the respective template (e.g., valid template 716) in the global template repository 210a. The valid template 716 generated for the action includes the sequence of steps for the respective action to be taken for converting the legacy software into the modern software.

FIG. 7B depicts another example illustration 700B of generating the template including the sequence of steps, in accordance with implementations of the present disclosure. Another example illustration 700B of generating the template for one of the actions based on the valid template 716 is depicted in FIG. 7B.

As depicted in FIG. 7B, the conversion system 108 uses the valid template 716 generated using the first template generation model 712 to generate the template for the respective action. The conversion system 108 inputs the valid template 716 or a syntax of the valid template 716, and the metadata 704 as the second template inputs to the second template generation model 720. In some examples, the second template inputs may be inputted to the second template generation model 720 using techniques such as NER, POS tagging, dependency parsing, Long Short-Term Memory (LSTM) based techniques, and/or the like. The second template generation model 720 is trained to generate the template based on the second template inputs. The conversion system 108 performs a validation 722 to determine whether the generated template based on the second template inputs is valid or not. The validation 722 may be performed similar to the validation 714, therefore repeated description is omitted herein for sake of brevity.

When it has been determined that the generated template based on the second template inputs is not valid, the conversion manager 228 repeats inputting of the second template inputs to the second template generation model 720 for subsequent generation of the template.

When it has been determined that the generated template based on the second template inputs is valid, the conversion system 108 updates the global template repository 210a with the template that is valid (e.g., valid template 724). The valid template 724 may include the sequence of steps for the respective action to be taken for converting the legacy software into the modern software.

Therefore, using the first and second template generation models 712-720, a multiple chained of templates is generated for the actions to be taken for converting the legacy software into the modern software.

FIG. 8 depicts an example illustration 800 of generating the prompts for the foundation model steps, in accordance with implementations of the present disclosure. In some examples, generating the templates for the actions involve generating the prompts for the foundation model steps. Generating the prompts for the foundation model steps in the template is described in detail below.

As depicted in FIG. 8, the conversion system 108 calls the prompt generation model 804 using the prompt inputs 802 to generate the prompts and the associated roles and parameters 806. The prompt inputs 802 may include the action and the foundation model steps in the associated template.

The conversion system 108 performs a validation 808 to determine whether the generated prompts and the associated roles and parameters 806 are valid. If the generated prompts and the associated roles and parameters 806 are not valid, the conversion system 108 repeats calling of the prompt generation model 804 to generate the prompts and the associated roles and parameters using the prompt inputs 802.

If the generated prompts and the associated roles and parameters are valid, the conversion system 108 performs a save operation 810 to store the prompts and the associated roles and parameters 806 in the prompt database 216.

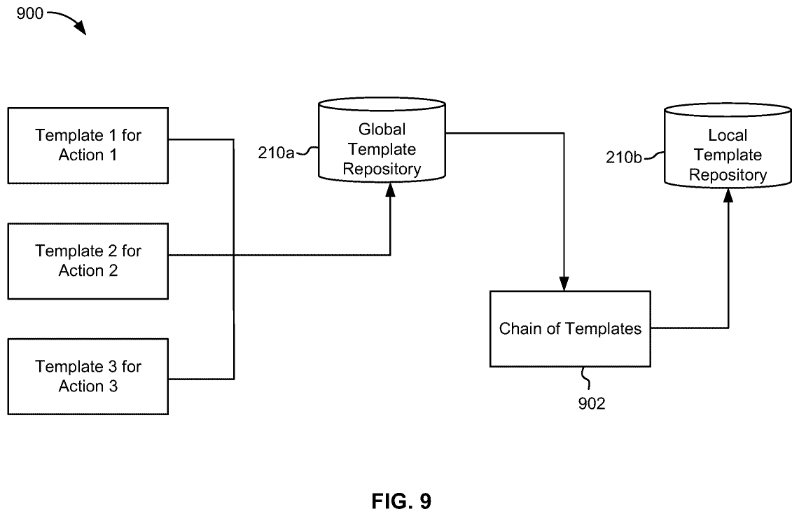

FIG. 9 depicts an example illustration 900 of updating the templates in the global and local template repositories 210a-210b, in accordance with implementations of the present disclosure.

For example, as depicted in FIG. 9, consider a scenario where templates 1, 2, and 3 are generated for actions 1, 2, and 3. Each of the templates 1, 2, and 3 may include the foundation model steps including prompts and the non-foundation model steps.

Upon generating the templates 1, 2, and 3, the conversion system 108 pre-processes the templates 1, 2, and 3 and performs one or more analysis on the pre-processed templates 1, 2, and 3. The one or more analysis may be performed to check whether the templates 1, 2, and 3 include any Personal Identifiable Information (PII) or any confidentiality information (e.g., credentials, passwords, and/or the like). If the templates 1, 2, and 3 include any PII, the conversion system 108 masks the PII in the templates 1, 2, and 3 with generic commands. If the templates 1, 2, and 3 include any confidentiality information, the conversion system 108 masks the confidentiality information in the templates 1, 2, and 3 with generic commands or removes the confidentiality information in the templates 1, 2, and 3.

Once the PII and/or the confidentiality information are masked/removed, the conversion system 108 sends the templates 1, 2, and 3 to the client device 106 for approval or rejection by the associated user. If the user rejects the templates 1, 2, and 3, the conversion system 108 rejects the templates 1, 2, and 3. If the user approves the templates 1, 2, and 3, the conversion system 108 saves the templates 1, 2, and 3 in the global template repository 210a.

After saving the templates 1, 2, and 3 in the global template repository 210a, the conversion system 108 manages the templates 1, 2, and 3 stored in the global template repository 210a for further storing in the local template repository 210a. In an example herein, managing the templates 1, 2, 3 may include creating a chaining of templates 902. In some examples, the conversion system 108 may create the chaining of templates 902 by performing one or more of: prompt compression, prompt de-duplication, prompt concatenation, and handling vendor/content differences in the prompts. The conversion system 108 may further save the chaining of templates 902 in the local template repository 210b.

FIG. 10 depicts an example illustration 1000 of generating the quality metrics for the foundation model steps in the templates, in accordance with implementations of the present disclosure. The conversion system 108 generates the templates for the respective actions to be identified for converting the legacy software into the modern software. Each of the templates includes the foundation model steps and the non-foundation model steps. For evaluating results of execution of the foundation model steps, the conversion system 108 generates the quality metrics. For example, the conversion system 108 may generate the one or more quality metrics for each of the foundation model steps. In some implementations, the conversion system 108 accesses the step-metric mapping from the entity knowledge database 208 and determines the one or more quality metrics for each of the foundation model steps.

As depicted in FIG. 10, if the foundation model steps are corresponding to the action like summary 1002a, the conversions system 108 generates the quality metrics such as Recall Oriented Understudy for Gisting Evaluation (ROGUE) and Bilingual Evaluation Understudy (BLEU) 1004a. The ROGUE may be used to content overlap between the results of execution of the foundation model steps and the prompts generated for the respective foundation model steps. The BLEU may be used to capture word-by-word similarity in the results of execution of the foundation model steps and the prompts generated for the respective foundation model steps.

If the foundation model steps are corresponding to the action like language translation 1002b, the conversions system 108 generates the quality metric like Metric for Evaluation of Translation with Explicit Ordering (METEOR) 1004b. The METEOR may be used to capture precision and recall in the results of execution of the foundation model steps and the prompts generated for the respective foundation model steps.

If the foundation model steps are corresponding to the action like code translation 1002c, the conversions system 108 generates the quality metric like Cosine similarity 1004c. The Cosine similarity may be used to evaluate similarity between the results of execution of the foundation model steps and the prompts generated for the respective foundation model steps.

If the foundation model steps are corresponding to the action like code generation/recommendation 1002d, the conversions system 108 generates the quality metric like perplexity 1004d. The perplexity may be used to measure confidence of the foundation models in executing the foundation model steps.

If the foundation model steps are corresponding to the action like test case generation 1002e, the conversions system 108 generates the quality metric like diversity 1004c.

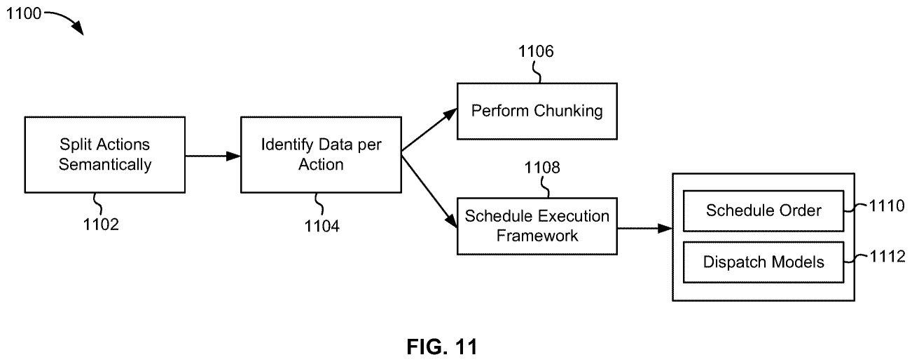

FIG. 11 depicts an example illustration 1100 of the execution pre-processing phase, in accordance with implementations of the present disclosure. During the execution pre-processing phase/stage, the conversion system 108 pre-processes the execution of the template/sequence of steps generated for each of the actions to be taken for converting the legacy software into the modern software.

As depicted in FIG. 11, during the execution pre-processing stage, the conversion system 108 semantically splits the actions identified for the legacy software into multiple semantic micro-jobs 1102 (e.g., 1 . . . . N). The multiple semantic micro-jobs 1102 may indicate distributed parallel processing jobs (DPP). In some examples, the conversion system 108 may use any of the foundation models 220a-220n for semantically splitting the actions into the multiple semantic micro-jobs 1102, based on requests received from the user of the client device 106 for splitting of the actions.

Further, the conversion system 108 identifies data 1104 (e.g., 1 . . . . M) of the legacy software required for each of the multiple semantic micro-jobs 1102. The data 1104 of the legacy software may include files or codes. The data 1104 may be accessed by scanning the content repositories 206a-206n. Therefore, the data 1104 for each of the micro-jobs 1102 of the actions may be mapped.

Thereafter, the conversion system 108 performs chunking 1106 on the data 1104 of the legacy software. Performing the chunking 1106 may include dividing each data (e.g., each file/code) into the multiple chunks using the appropriate chunking methodology, which is described in FIG. 12.

Upon performing the chunking 1106 on the data, the conversion system 108 schedules an execution framework 1108 for executing the template/sequence of steps for each of the actions on the respective chunks. The execution framework 1108 may indicate an order 1110 scheduled for performing the template/action on each of the chunks, and the foundation models 1112 dispatched/assigned for the foundation model steps in the template from the foundation models 220a-220n selected for the conversion, which is described in detail in conjunction with FIGS. 13A-13E. Once the execution framework 1108 is scheduled, the conversion system 108 executes templates/actions on the respective chunks using the assigned foundation models. Thereby, the chunks are efficiently processed. Processing of the chunks is described in detail in conjunction with FIGS. 14A-14D.

FIG. 12 depicts an example illustration 1200 of selecting the chunking methodology for performing the chunking of the data of the legacy software, in accordance with implementations of the present disclosure. The conversion system 108 decides to perform the chunking of the data of the legacy software, based on a size of the data.

For performing the chunking, the conversion system 108 selects the chunking methodology. Based on the selected chunking methodology, the conversion system 108 calculates a number of chunks to be generated per data of the legacy software. The number of chunks may be calculated based on one or more of: a type of the data of the legacy software, a maximum of token sizes inputted to the foundation models 220a-220n (selected for execution of the sequence of steps), and input token limits of the foundation models 220a-220n (if the quality metrics are required).

For example, as depicted in FIG. 12, if the data of the legacy software includes images 1202a, the conversion system 108 selects the image token based chunking method 1204a. The conversion system 108 further uses the image token based chunking method 1204a to divide the images 1202a into a ‘n’ number of chunks. For example, consider a scenario where the legacy software includes an image covered by 512×512 tiles. Each of the 512×512 tiles provide 170 tokens. In such a scenario, the ‘n’ number of chunks may be calculated as: n=w*h, wherein w=ceil (width/512) and h=ceil (height/512) for image tokens=≥(cv2 module). Further, a total number of image tokens may be computed as total tokens=85+170*n.

If the data of the legacy software includes an object-oriented programming (OOPs) code 1202b, the conversion system 108 selects the logical chunking 1204b for dividing the OOPs code into the multiple chunks. The logical chunking 1204b may operate based on functions, objects, classes, and/or the like of the OOPs code. If the data of the legacy software includes a non-OOPs code 1202c, the conversion system 108 selects the token based chunking 1204c for dividing the non-OOPs code 1202c into the multiple chunks.

If the data of the legacy software includes audio 1202d, the conversion system 108 selects the file-size based chunking 1204d for dividing the audio 1202d into the multiple chunks. In an example, a total number of chunks for the audio 1202d may be calculated as total chunks=size of audio file (in Mega Byte (MB))/25, for audio file size >25 MB.

If the data of the legacy software includes video 1202e, the conversion system 108 selects the duration-length based chunking 1204e. The duration-length based chunking 1204c may operate based on duration or length of the video 1202c.

FIGS. 13A, 13B, 13C, and 13D depict scheduling the execution framework for execution of the template/sequence of steps for each of the actions to be taken for converting the legacy software into the modern software, in accordance with implementations of the present disclosure.

The conversion system 108 receives the legacy software and identifies the actions 1302 to be taken for converting the legacy software into the modern software. The conversion system 108 scans the content repositories 206a-206n of the legacy software using the scan IDs 1304, for example, E11, E12, E21, and E22 and retrieves the files 1306 of the legacy software associated with such scan IDs 1304. In an example, as depicted in FIG. 13A, the actions 1302 identified for the scan IDs E11, E12, and E21 includes 5 files. Therefore, 10 files for the 2 actions identified for the scan ID E11, 50 files for the 10 actions identified for the scan ID E12, and 90 files for the 18 actions identified for the scan ID E21. The action identified for the scan ID E22 includes only one file.

Upon retrieving the files for the scan IDs E11, E12, E21, and E22, the conversion system 108 schedules an order 1308 for performing the actions 1302 associated with the scan IDs 1304. The order may be scheduled based on time of identification/submission of the actions. In some examples, the order for performing the actions may be scheduled using a First In First Out (FIFO) approach. An example order for performing the actions is depicted in FIG. 13A. The example order 1308 indicates that the actions associated with the scan ID E22 to be performed first following the actions associated with the scan IDs E12, E21, and E11.

In order to perform the actions 1302 in the scheduled order 1308, the conversion system 108 identifies resources, for example, the worker pods, available or dedicated for the actions of the legacy software. For example, as depicted in FIG. 13A, the conversion system 108 identifies that 3 worker pods are initially dedicated for the legacy software. Further, on a demand, a new worker pod may be created if a request for action increases. Accordingly, a worker pod 4 may be created. On a worker pod W1, the conversions system 108 selects processors P1 and P2 for a first action of the 2 and 18 actions associated with the scan IDs E11 and E21, respectively. The conversion system 108 selects a processor P3 on the worker pod W1 for a third action of the 10 actions associated with the scan ID E12. On a worker pod W2, the conversion system 108 selects a P1 and a P2 for a second action of the 2 and 18 actions associated with the scan IDs E11 and E21, respectively, and a P3 for a fourth action of the 10 actions associated with the scan ID E12. On a worker pod W3, the conversion system 108 selects a P1 for a first action of the 10 actions associated with the scan ID E12, a P2 for a third action of the 18 actions associated with the scan ID E21, and a P3 for the action associated with the scan ID E22. On a newly created worker pod W4, the conversion system 108 selects a P1 for a second action of the 10 actions associated with the scan ID E12, a P2 for a fourth action of the 18 actions associated with the scan ID E21, and a P3 for a fifth action of the 18 actions associated with the scan ID E21.

Upon selecting the processors/resources for the actions on the worker pods, the conversion system 108 identifies the templates selected for each of the actions 1302. For example, a template T1 may be selected for the first action of the actions associated with the scan ID E11, as depicted in FIG. 13A. The template T1 includes 10 foundation model steps (FS) and 10 non-foundation model steps (NFS). It should be noted that each of the 5 files associated with the scan ID E11 may be divided into the multiple chunks and each of the first action may be scheduled on each of the chunks. Therefore, the sequence of steps of the template T1 identified for the first action to be performed on each of the chunks.

After assigning the templates for each of the actions 1302, the conversion system 108 assigns the one or more foundation models for the foundation model steps in each of the templates from the foundation models 220a-220n selected for the conversion. For simplicity, assigning of the foundation models for the foundation model steps in the template is described in detail below, however, it may be applicable for assigning the foundation models for all the templates.

In some implementations, the conversion system 108 may assign the foundation models for the template based on a model reputation score of each of the foundation models 220a-220n selected for the conversion. In an example, as depicted in FIG. 13B, the conversion system 108 assigns the foundation models 220a, 220b, 220c, and 220d for the template T1 based on the model reputation scores of the foundation models 220a-220n. The model reputation score of each of the foundation models 220a-220n may be calculated (described in detail in conjunction with FIG. 13D) based on a region in which the foundation models 220a-220n have been deployed, an assigned TPM quota, a fair share factor, a collusion rate per min, a success rate per min, Walts per min, a number of requested that can be served by each of the foundation models 220a-220n. Upon assigning the foundation models for the template, the conversion system 108 calculates the cost and parameters associated with the template and optimizes usage of the assigned foundation models for the foundation model steps in the template, which is described along with FIG. 13C.

As depicted in FIG. 13C, the conversion system 108 provides input features 1310 to the trained linear regression model 1312. The input features 1310 may include a total number of sequence of steps in the template, a number of foundation model steps (FS) in the template, a number of non-foundation model steps (NFS) in the template, a demography in which the foundation models assigned for the template are deployed, a number of prompts in the sequence of steps, a number of chunks generated for the data of the legacy software, TPMs of the foundation models (e.g., foundation models 220a-220d) assigned for the template, and/or the like. The trained linear regression model 1312 may be used to determine a target label 1314 based on the provided input features. The target label 1314 may indicate the cost and time parameters associated with the template.

Once the cost and time parameters are determined, the conversion system 108 performs optimization actions 1316 for optimizing usage of the assigned foundation models 220a-220d assigned for the template. The optimization actions 1316 may include identifying features (e.g., a type, a vendor, and a functionality) of each of the foundation models 220a-220d, determining parameters (e.g., budget/cost, accuracy, and speed) for each of the foundation models 220a-220d based on their features, and performing a trade-off between the parameters to optimize the usage of the foundation models 220a-220d.

For example, the foundation models 220a and 220b may be associated with the parameters such as low quality of output and low budget. Alternatively, the foundation models 220c and 220d with the advanced functionality may be associated with the parameters such as high quality of output, high budget, and high speed for such foundation models. Therefore, the conversion system 108 compares the foundation models 220a-220d in terms of their features and parameters. Based on the comparison, the conversion system 108 identifies the appropriate foundation model for each of the foundation model steps in the template, which further satisfies the cost and time parameters associated with the template. For example, the conversion system 108 may assign the foundation model 220c for a first foundation model step in the template, which is associated with the action that requires high speed. Similarly, the conversion system 108 may assign the foundation model 220a for a fourth foundation model step in the template, which is associated with the action that requires low budget.

In some other implementations, the conversion system 108 selects and assigns the foundation models for the foundation models based on the TPM.

For an example, consider that TPM per foundation model=Maximum ((Maximum number of tokens per chunk)*N, Maximum available TPM for the deployment).

For another example, consider that a maximum available TPM for deployment includes 200K TPM, a maximum number of tokens per chunks includes 8K, TPM per foundation model is equal to Maximum ((8*3), 200)=Maximum (24K,200K)=24K, and total number of models=200//24=8. In such a case, the TPM per foundation model=Maximum ((Maximum number of tokens per chunk)*4, Maximum available TPM for the deployment), if the legacy software is a large monolithic code. If the legacy software is a small Oops based code, the TPM per foundation model=Maximum ((Maximum number of tokens per chunk)*2, Maximum available TPM for the deployment).

The total number of foundation models may be selected for the conversion=Maximum TPM of the deployment//TPM per foundation model.

In some other implementations, as depicted in FIG. 13D, the conversion system 108 assigns the foundation models for the template based on the model reputation score of each of the foundation models 220a-220n selected for the conversion and the action corresponding to the foundation model steps (FS) in the template.

As depicted in FIG. 13D, the conversion system 108 inputs the foundation model steps of the template and the action corresponding to the template as model assignment inputs 1320 to the recommendation model 1322. The conversion system 108 identifies the prompts generated for the template. Accordingly, the conversion system 108 performs a semantic search on the domain database 204 to access prompts 1326a similar to the prompts generated for the template. The conversion system 108 also accesses types 1326b of the foundation models associated with the similar prompts 1326a. The conversion system 108 provides the similar prompts 1326a and the associated types 1326b of the foundation models to the recommendation model 1322. Based on the model assignment inputs 1320, the similar prompts 1326a, and the associated types 1326b of the foundation models, the recommendation model 1322 generates model parameters 1328. The conversion system 108 uses the model parameters 1328 to perform a reputation score calculation 1330. The model parameters 1328 may include model regions, TPM quota for each of the model regions, one or more of the foundation models 220a-220n deployed in each of the model regions, deployments performed for one or more of the foundation models 220a-220n in each of the model regions, sustainability and aggregated reputation scores associated with each of the model regions, factors associated with each of the foundation models 220a-220n, and/or the like. The factors associated with each of the foundation models 220a-220n may include a fair share factor, a collision rate per minute, a success rate per minute, Walts per minute, a number of requests successfully served, and/or the like. The fair-share factor the foundation model 220a-220n indicate TPM quota used by the foundation model 220a-220n in real-time. With the fair-share factor, the unused TPM may be provided/taken to/from other foundation models, which further results in dynamic model switching within the same type of the foundation models. The Walts per minute (‘W’) of the foundation model may be calculated as W=(number of works/actions in exponential backoff on the foundation model/number of requests received for the actions)*100. The collision failure rate (‘F’) of the foundation model may be calculated as F=(number of works/actions experience failure on the foundation model/number of requests received for the actions)*100. The success rate (‘S’) of the foundation model may be calculated as S=(number of works executed successfully on the foundation model/number of requests received for the actions)*100. Exemplary model parameters 1328 are described in an example table below:

TABLE 1
Exemplary Model Parameters

| Region | R1 | R2 | R3 | Rn |
|---|---|---|---|---|
| Total Deployment | Q1 | Q2 | Q3 | Qn |
| Quota | (200KTPM) | (10KTPM) | (50KTPM) | (200KTPM) |
| Sustainability Score | High | High | Low | Low |
| Aggregated | Low | Medium | High | High |
| Reputation Score | | | | |
| Deployments done | 10 models 20K | 1 model | 1 model | 1 model |
| for models | TPM each | 10KTPM | 50KTPM | 200KTPM |
| Models | Model 202a, | Model 202b | Model 202c | Model 202n |
| | Model 202d . . . | | | |

The reputation score calculation 1330 performed by the conversion system 108 includes calculating reputation scores 1332 of the foundation models 220a-220n based on the model parameters 1328. Upon calculating the reputation scores 1332, highest/maximum reputation scores 1334 among the calculated reputation 1332 are identified. Further, the foundation models, for example, foundation models 220a-220d associated with the maximum reputation scores 1334 are identified. From the identified foundation models 220a-220d, a foundation model (e.g., foundation model 220a) is assigned for a first foundation model step of the foundation model steps in the template. Further, information 1338 about the selected foundation model 220a is stored in the domain database 204. The above-described reputation score calculation 1330 may be subsequently performed to assign subsequent/next foundation models for the subsequent foundation model steps in the template.

Therefore, assigning the foundation models for the foundation model steps by performing weighted exponential backoff based on the model reputations scores improves worker pods overload, rate limits, and waiting time, while increasing speed of processing the foundation model steps.

FIG. 13E depicts another example illustration of scheduling the execution framework including assigning the foundation models for the foundation model steps based on the hosting infrastructures of the foundation models, in accordance with implementations of the present disclosure.

During the execution pre-processing phase/stage, as depicted in FIG. 13E, the conversion system 108 divides the data of the legacy software, for example, a code 1352, into chunks 1, 2, and 3. The conversion system 108 identifies the action to be performed on the code 1352 and the template associated with the action. The template includes the sequence of steps, which further includes the foundation model steps and the non-foundation model steps. The conversion system 108 identifies the foundation model steps from the template and maps each of the chunks 1, 2, and 3 with the foundation model steps. The conversion system 108 may map the chunks 1, 2, and 3 with the foundation model steps may indicate that the foundation model steps to be executed on each of the chunks 1, 2, and 3. Implementations of the present disclosure are further described herein by considering a single foundation model step to be executed on each of the foundation model steps, for case of understanding.

As depicted in FIG. 13E, the conversion system 108 generates a first prompt 1354 for the foundation model step mapped with the chunks 1, 2, and 3. Thereafter, the conversion system 108 checks if the foundation model step includes code explanation or instructions 1356. If the foundation model step includes the code explanation or instructions 1356, the conversion system 108 decides to select the foundation models hosted on a hosting infrastructure 1358. If the foundation model step does not include the code explanation or instructions 1356, the conversion system 108 checks if the foundation model step includes the code generation or translation 1360. If the foundation model step includes the code generation or translation 1360, the conversion system 108 decides to select the foundation models hosted on a hosting infrastructure 1362. It should be noted that the foundation models hosted on the hosting infrastructures 1358 and 1362 may constitute the foundation models 220a-220n, as depicted in FIG. 2.

For selecting the foundation models on the hosting infrastructure 1358, the conversion system 108 performs a first check 1364 to determine if a foundation model A1 in a region 1 is available. If the foundation model A1 in the region 1 is available, the conversion system 108 assigns the foundation model A1 to generate a summary 1366a and an instruction 1366b of the chunk 1. If the foundation model A1 in the region 1 is not available, the conversion system 108 performs a second check 1367 to determine if a foundation model A2 in a region 2 is available. If the foundation model A2 in the region 2 is available, the conversion system 108 assigns the foundation model A2 to generate a summary 1368a and an instruction 1368b of the chunk 2. If the foundation model A2 in the region 2 is not available, the conversion system 108 performs a third check 1370 to determine if a foundation model A3 in a region 3 is available. If the foundation model A3 is not available, the conversion system 108 checks for the previous foundation models A2 and A3. If the foundation model A3 in the region 3 is available, the conversion system 108 assigns the foundation model A3 to generate a summary 1372a and an instruction 1372b of the chunk 3. The summaries 1366a, 1368a, and 1372a of the chunks 1, 2, and 3, respectively may be further used to generate a second prompt 1374. The instructions 1366b, 1368b, and 1372b of the chunks 1, 2, and 3, respectively may be further used to generate a third prompt 1376. The second prompt 1374 may be used for re-tuning of the first prompt 1354 for subsequent generations of the summary and instructions. The third prompt 1376 may be used for re-determination of the foundation model step associated with the chunks 1, 2, and 3 and accordingly further operations may be performed.

For selecting the foundation models on the hosting infrastructure 1362, the conversion system 108 performs a first check 1380 to determine if a foundation model B1 in a region 1 is available. If the foundation model B1 in the region 1 is available, the conversion system 108 assigns the foundation model B1 to generate a code 1382 of the chunk 1. If the foundation model B1 in the region 1 is not available, the conversion system 108 performs a second check 1384 to determine if a foundation model B2 in a region 2 is available. If the foundation model B2 in the region 2 is available, the conversion system 108 assigns the foundation model B2 to generate a code 1386 of the chunk 2. If the foundation model B2 in the region 2 is not available, the conversion system 108 performs a third check 1388 to determine if a foundation model B3 in a region 3 is available. If the foundation model B3 is not available, the conversion system 108 checks for the previous foundation models B1 and B2. If the foundation model B3 in the region 3 is available, the conversion system 108 assigns the foundation model B3 to generate a code 1390 of the chunk 3. The code 1382, the code 1386, and the code 1390 of the chunks 1, 2, and 3, respectively may be further used to perform a code comparison 1392.

FIGS. 14A, 14B, and 14C depict exemplary illustrations 1400A, 1400B, and 1400C of performing the chunking of the data of the legacy software into the multiple chunks and processing of the multiple chunks, in accordance with implementations of the present disclosure. The conversion system 108 receives the data of the legacy software from the content repositories 206a-206n. In an example herein, the data of the legacy software may include input files/documents/codes. The conversion system 108 divides each of the files into multiple chunks.

As depicted in FIGS. 14A, 14B, and 14C, the conversion system 108 receives the file 1402 for chunking. In an example, consider that the received file 1402 may be of a size greater than 8 thousand (K) token limit. If such a file 1402 is passed to any of the foundation models 220a-220n (selected for the conversion) entirely, the respective foundation model may hallucinate. Therefore, the conversions system 108 divides the file 1402 into multiple chunks, for example, three chunks 1, 2, and 3. Each chunk may be associated with a size of lesser than the 8K token limit. The conversion system 108 identifies the action for each of the files and the template including the foundation model steps generated for the action. Therefore, the foundation model steps in the template corresponding to the action may be executed on each of the respective chunks. As a non-limiting example, consider herein that the foundation model step to be executed on each of the chunks 1, 2, and 3 for the action like explanation or summarization of codes in the file 1402.

Further, the conversion system 108 identifies that the prompts 1404, 1406, and 1408 are generated for executing the foundation model step on each of the chunks 1, 2, and 3 and retrieves the prompts 1404, 1406, and 1408 from the prompt database 216. Further, the conversion system 108 identifies that the foundation model 220a and a second foundation model 220b from the foundation models 220a-220n (selected for the conversion) are assigned for executing the foundation model step on the chunks 1 and 2 respectively. The conversion system 108 further identifies that the foundation model 220a is identified for executing the foundation model step on the chunk 3. Thereafter, the conversion system 108 processes the chunks 1, 2, and 3 by executing the foundation model steps on the chunks 1, 2, and 3 using the respectively assigned foundation models 220a, 220b, and 220a and the prompts 1404, 1406, and 1408.

In parallel, the conversion system 108 reads a chunk, for example, a chunk 1, from chunks derived for another file 1410. The file 1402 and another file 1410 may be semantically connected to each other. The conversion system 108 creates a prompt 1412 and calls any of the foundation models 220a-220n (selected for the conversation) with the created prompt to generate a summarization 1414 for the chunk 1 of another file 1410. The conversion system 108 uses the summarization 1414 as an external context input 1416 for processing the chunks 1, 2, and 3 of the file 1402.

In some implementations, the conversion system 108 processes the chunks 1, 2, and 3 by using an internal context input as well the external context input 1416. For example, as depicted in FIG. 14A, the conversion system 108 inputs the first prompt 1404 and the external context input 1416 (including the summarization 1414) to the first foundation model 220a to generate a summarization 1418 of the chunk 1. The summarization 1418 of the chunk 1 may act as the internal context input 1420 for the foundation model 220b. The conversion system 108 inputs the second prompt 1406, the external context input 1416, and the internal context input 1420 to generate a summarization 1422 of the chunk 2. The summarization 1422 of the chunk 2 may act as the internal context input 1424 for the foundation model 220a. The conversion system 108 inputs the third prompt 1408, the external context input 1416, and the internal context input 1424 to the first foundation model 220a to generate a summarization 1426 of the chunk 3.

In some other implementations, the conversion system 108 processes the chunks 1, 2, and 3 using the external context input 1416. For example, as depicted in FIG. 14B, the conversion system 108 inputs the first prompt 1404 and the external context input 1416 to the first foundation model 220a to generate the summarization 1418 of the chunk 1. The conversion system 108 inputs the second prompt 1406 and the external context input 1416 to generate the summarization 1422 of the chunk 2. The conversion system 108 inputs the third prompt 1408 and the external context input 1416 to the first foundation model 220a to generate the summarization 1426 of the chunk 3.

In yet other implementations, the conversion system 108 processes the chunks 1, 2, and 3 by using the internal context input. For example, as depicted in FIG. 14C, the conversion system 108 inputs the first prompt 1404 to the first foundation model 220a to generate the summarization 1418 of the chunk 1. The summarization 1418 of the chunk 1 may act as the internal context input 1420 for the foundation model 220b. The conversion system 108 inputs the second prompt 1406 and the internal context input 1420 to generate the summarization 1422 of the chunk 2. The summarization 1422 of the chunk 2 may act as the internal context input 1424 for the foundation model 220a. The conversion system 108 inputs the third prompt 1408 and the internal context input 1424 to the first foundation model 220a to generate the summarization 1426 of the chunk 3.

Once the summarizations 1418, 1422, and 1426 are generated for the chunks 1, 2, and 3, the conversion system 108 generates a final summary 1430 for the summarizations 1418, 1422, and 1426 conquering the external context input 1416. For example, as depicted in FIGS. 14A, 14B, and 14C, the conversion system 108 generates a final prompt 1428 for the summarizations 1418, 1422, and 1426. The conversion system 108 inputs the final prompt 1428 and the external context input 1416 to any of the foundation models 220a-220n for generating the final summary 1430.

In some implementations, as depicted in FIG. 14D, the conversion system 108 generates a refined summary 1434 by performing a post-processing 1432 of the final summary 1430. The post-processing 1432 of the final summary 1430 includes string replacement, regex removal, redundant context removal, semantic concatenation, whitespace removal, data masking, and sentence splitting and paragraphing.

In some examples, for the sentence splitting and paragraphing, the conversion system 108 breaks/divides a text in the final summary 1430 into individual tokens using tokenizer functions provided by in-built NLP libraries. The tokens may include words, punctuation marks, and/or the like. Further, the conversion system 108 identifies boundaries between sentences in the text based on the tokens. For example, the boundaries may be identified by detecting the punctuation marks (e.g., periods, exclamation points, question marks, and/or the like) that indicate an end of the sentence. The boundaries may be identified using NLP libraries that offer pre-trained models or rules-based approaches for detection of the boundaries. Once the sentences are identified, the conversion system 108 group the sentences into paragraphs based on criteria such as, maximum number of sentences per paragraph or presence of blank lines between the paragraphs.

Therefore, implementations of the present disclosure generate the refined summary by:
Overcoming token limits: The refined summary may be generated by surpassing limitations imposed by token constraints and enabling greater flexibility and creativity in the refined summary.
Using text fusion techniques to merge the sentences, specifically code.
Using the NLP techniques rather than normal concatenating techniques to generate the refined summary.
Ensuring high-quality output: The summarizations including lengthy outputs may be maintained with quality standards.

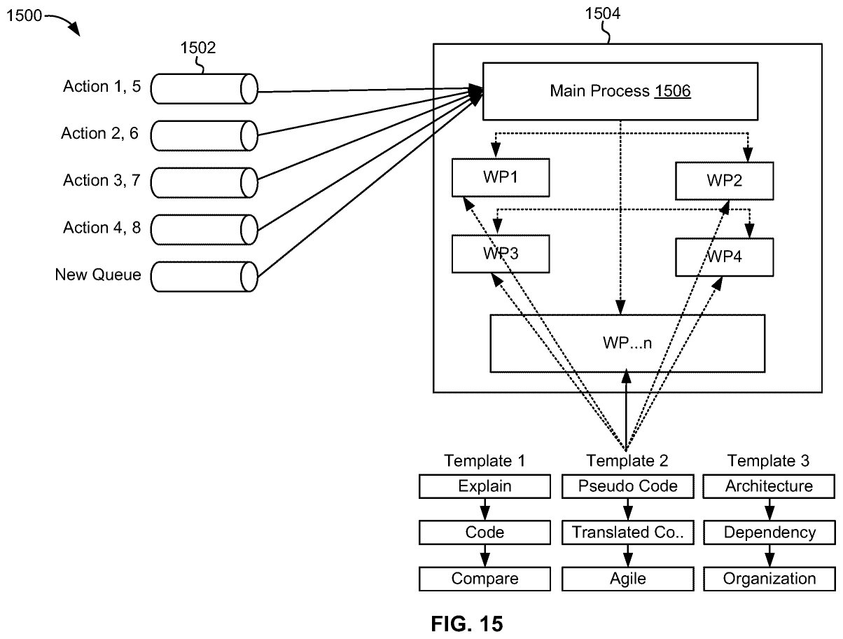

FIG. 15 depicts an example illustration 1500 of allocating the actions to the templates/sequence of steps and executing the sequence of steps using the worker pods, in accordance with implementations of the present disclosure.

The conversion system 108 adds the actions to a FIFO queue 1502 in accordance with the scheduled order. In parallel, the conversion system 108 provides the templates (each template including the sequence of steps) identified for the actions to the worker pod 1504. The sequence of steps identified in each of the templates for each of the actions may be considered as worker processes (e.g., WP1, WP2, WP3, WP4, . . . . WPn).

As depicted in FIG. 15, the worker pod 1504 includes a main process 1506, which manages the worker processes and reads the actions from the queue 1502. When there are multiple queues, the main process 1506 reads the actions from all the queues in a round robin fashion. Once the actions have been read, the main process 1506 allocates/maps the actions to the worker processes. Thereafter, the worker processes may be then executed using the resources of the worker pod 1504 and in accordance with the scheduled execution framework. Thereby, the actions may be executed, which result in generation of the modern software for the legacy software.

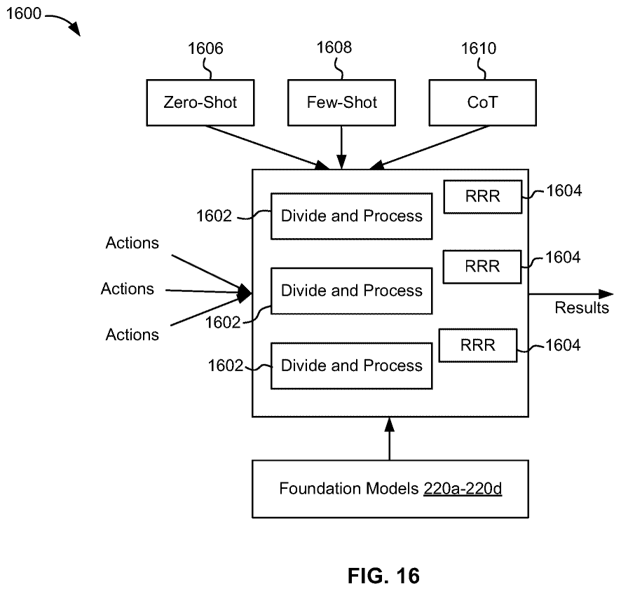

FIG. 16 depicts an example illustration 1600 of controlling execution of the sequence of steps including the foundation model steps, in accordance with implementations of the present disclosure. The conversion system 108 identifies the actions for the legacy software, which is to be converted/modernized into the modern software. For example, consider that the actions include “look into documents D1 and D2, understand diagram P2, consider the copybooks B1, and B2, and then explain a related code C”. The conversion system 108 retrieves data of the legacy software for the actions. Further, the conversion system 108 performs divide and process operations 1602 to divide the data into the multiple chunks and to process the chunks.

For performing the divide and process operations 1602, the conversion system 108 identifies the action associated with each of the chunks and identifies the template including the foundation model steps for the action. Therefore, the foundation model steps may be executed on each of the respective chunks. The conversion system 108 further assigns the foundation models, for example, foundation models 220a-220d, for the foundation model steps. The conversion system 108 further processes the chunks by executing the respectively identified foundation model steps on the chunks using the assigned foundation models 220a-220d and generate the results. The results may correspond to outputs of the actions.

In accordance with implementations of the present disclosure, the conversion system 108 performs the retry, rephrase, and regenerate (RRR) functions 1604 to evaluate the results of execution of the foundation model steps on the chunks. The RRR functions 1604 may be performed till the results of execution of the foundation model steps are the quality outcomes, which is described in detail in conjunction with FIG. 17. The RRR functions may involve tuning the HPs of the foundation models 220a-220d, rephrasing the prompts for the foundation model steps, fine-tuning of the foundation models 220a-220d using learning examples, such as, but not limiting to, zero-shot learning examples 1606, few-shot learning examples 1608, and Chain of Thought (CoT) examples 1610 (accessed from the domain database 204).

FIG. 17 depicts an example illustration 1700 of performing the RRR functions, in accordance with implementations of the present disclosure.

The conversion system 108 access SME guidelines 1702 from the domain database 204. In some examples, the domain database 204 may be periodically updated with publicly available SME documentations 1704. The SME documentations 1704 may refer to materials or documents created or provided by a SME having a deep expertise or knowledge of the legacy software. The SME documentations 1704 may include detailed information, guidelines, processes, best practices, and insights that are crucial for conversion of the legacy software into the modern software. For example, the SME documentations 1704 may include technical documentations, training materials, process documentations, knowledge transfer documentations, and/or the like. The technical documentations may include guides, manuals for software, hardware, and/or the like. The training materials may include resources used for conversion of the legacy software into the modern software. The process documentation may refer to detailed descriptions of enterprise processes, procedures, workflows, and/or the like. The knowledge transfer documentations may refer to information shared for ensuring continuity of expertise within the organization.

Using the SME guidelines, the conversion system 108 generates the prompts 1706 for the templates corresponding to the actions to be taken for converting the legacy software into the modern software. The conversion system 108 includes the generated prompts 1706 in the respective templates 1708. Each of the templates 1708 include the foundation model steps and the non-foundation model steps. As the RRR functions are applicable for the foundation model steps, implementations of the present disclosure are described further by considering the foundation model steps.

Further, the conversion system 108 generates results 1710 (e.g., outputs, contents, or the like) by executing the foundation model steps in accordance with the scheduled execution. In accordance with the scheduled execution framework, the foundation model steps are executed using the respectively assigned foundation models. The results 1710 may form the data of the modern software. Further, the conversion system 108 identifies the data 1712 of the legacy software on which the foundation model steps are executed. In addition, the conversion system 108 identifies the quality metric(s) 1714 generated for the foundation model steps (e.g., for evaluation of the results of execution of the foundation model steps).

The conversion system 108 generates the quality scores 1716 for the results 1710 by performing a quality check on the results 1710 and the data 1712 of the legacy software. For example, if the quality metric 1714 includes a cosine similarity metric, the conversion system 108 converts the results 1710 and the data 1712 into their vector representations and measures cosine of angle between the vector representations of the results 1710 and the data 1712 to generate the quality scores 1716 for the results 1710. The quality scores 1716 of the results 1710 may indicate similarities between the results 1710 and the data 1712. The conversion system 108 further performs a comparison 1718 to check if the quality scores 1716 of the results 1710 with the pre-determined threshold score (e.g., depicted as TS in FIG. 17). The comparison 1718 is performed by considering the cosine similarity metric as the quality metric. However, it should be noted that the quality scores, the threshold score, and the comparison 1718 may vary depending on the quality metrics generated for the foundation model steps.

If the quality scores 1716 of the results 1710 fall below the threshold score, the conversion system 108 performs the retry function 1720. If the quality scores 1716 of the results 1710 fall within a larger range (e.g., depicted as LR in FIG. 17) of the threshold score, the conversion system 108 performs the rephrase function 1725. For example, the threshold score may be 0.9 and the larger range of the threshold score may be 0.5.

For performing the retry function 1720, the conversion system 108 checks if the number of retry counts 1722 is lesser than the pre-determined retry count (e.g., ‘n’). The number of retry counts 1722 may indicate how many times the retry function 1720 has already been performed and ‘n’ may indicate a maximum number of times the retry function 1720 may be performed. If the number of retry counts 1722 is lesser than ‘n’, the conversion system 108 identifies the foundation models associated with the results 1710 having the quality scores 1716 fall below the threshold score. The conversion system 108 further decides to tune the HPs 1724 of the identified foundation models. The conversion system 108 retries 1726 to derive the results 1710 by executing the respective one or more of the foundation model steps using the tuned one or more of the foundation models through a nested loop and calculates the quality scores 1716 for the derived results 1710. The conversion system 108 determines if the quality scores 1716 of the results 1710 fall above or equal to the threshold score. If the quality scores 1716 fall below the threshold score, the conversion system 108 repeats generation of the results 1710 and performs the retry function 1720. The conversion system 108 performs the retry function 1720 until the number of retry counts reaches the predetermined retry count or the quality scores 1716 of the results 1710 fall above or equal to the threshold score. Thereafter, the rephrase function 1725 is initiated.

For performing the rephrase function 1725, the conversion system 108 checks if the number of rephrase counts 1728 is lesser than the pre-determined rephrase count (e.g., ‘m’) and the quality scores 1716 of the results 1710 fall below the threshold score. If the number of rephrase counts 1728 is lesser than ‘m’ and the quality scores 1716 of the results 1710 fall below the threshold score, the conversion system 108 rephrases the prompts 1706 to generate rephrase prompts 1730. Further, the conversion system 108 derives the results 1710 by executing the foundation model steps using the rephrased prompts 1730. Accordingly, the conversion system 108 calculates the quality scores 1716 for the derived results 1710. The conversion system 108 performs the rephrase function 1725 till the number of rephrase counts 1728 reaches ‘m’ and/or the quality scores 1716 of the results 1710 fall below the threshold score. Thereafter, the regenerate function 1732 is initiated.

For performing the regenerate function 1732, the conversion system 108 fine-tunes the foundation models to generate the fine-tuned foundation models 1734. The foundation models may be fine-tuned using the zero-shot examples, the few-shot examples, and the CoT examples. The zero-shot examples, the few-shot examples, and the CoT examples may be accessed using the domain database 204. After fine-tuning the foundation models, the conversion system 108 performs reinitiation functions 1736 and 1738 to reinitiates the retry function 1720 and the rephrase function 1725 until the quality scores 1716 of the results 1710 fall above or equal to the threshold score.

After performing the retry function 1720, or the rephrase function 1725, or the regenerate function 1732, if the quality scores 1716 of the results 1710 fall above the threshold score, the conversion system 108 selects the result having the highest quality score 1740 among the results 1710. The conversion system 108 stores the selected result with the highest quality score 1740 and the associated prompt in the vector database 212. Further, the conversion system 108 updates the selected prompt in the respective template stored in the local template repository 210b. The updates from the local template repository 210b may be pushed to the global template repository 210a.

The proposed RRR functions may reduce hallucinations that may incur at the foundation models. Further, with the RRR functions, the foundation models may be operated efficiently as the RRR functions reduce the manual effort required in generation of the prompts. In addition, the RRR functions aid in generating the simple and efficient prompts.

FIG. 18 depicts an example illustration 1800 of generating the graphs for the results of the execution of the templates for the actions, in accordance with implementations of the present disclosure. Generation of the graph for each of the actions is described in detail below.

As depicted in FIG. 18, the conversion system 108 creates graph inputs 1802 by including the action and the associated template and results, the process management levels defined by the entity, and the summary of the results. The conversion system 108 calls the schema generation model 1804 using the graph inputs 1802 to generate a schema, a query for creating nodes, and relationships among the results 1806. Once the query is generated, the conversion system 108 inputs the query to the first query generation model 1808 for generating a cypher query 1810. The cypher query 1810 may be a query generated in a graph query language. The conversion system 108 executes the cypher query 1810 to generate the graph 1812 for the action. If the conversion system 108 fails to generate the graph using the first query generation model 1808, the conversion system 108 repeats calling of the schema generation model 1804 and the first query generation model 1808 for subsequent generation of the cypher query 1810 and the graph 1812.

In some implementations, the conversion system 108 inputs the graph 1812 to the second query generation model 1814 to generate a graph-based cypher query 1816. The graph 1812 may be inputted to the second query generation model 1814 using the techniques such as NER, POS tagging, and dependency parsing. The conversion system 108 executes the graph-based cypher query 1816 to generate the refined graph 1818. The conversion system 108 stores the refined graph 1818 generated for the action in the graph database 214. If the conversion system 108 fails to generate the graph using the second query generation model 1814, the conversion system 108 repeats calling of the schema generation model 1804 and the first query generation model 1808 for subsequent generation of the cypher query 1810 and the graph 1812.

The graph 1812/1818 may be used to intricately map and illustrate relationships within the functional and technical components, dependencies, and/or the like of the legacy/modern software for detailed comprehension. Further, the graph 1812/1818 may be accessed with default, custom views, filters, dependencies, and/or the like. Further, conversations may be initiated on the graph 1812/1814.

FIG. 19 depicts an example illustration 1900 of creating the collaborative platform, in accordance with implementations of the present disclosure.

As depicted in FIG. 19, the conversion system 108 creates section inputs 1902 by including the actions, the process management levels defined by the entity, and the template. The conversion system 108 inputs the section inputs 1902 to the first sections generation model 1904 to generate the sections 1906. The sections 1906 may correspond to the different actions. The section corresponding to the action may include one or more of: the action and documentation or summarization of the results, artifacts (e.g., epics, features, or the like), successful conversions, data models, data dictionaries, and/or the like, associated with the respective action. Upon generation sections, the conversion system 108 inputs the sections 1906 to the configurations generation model 1908 to generate configurations 1910 for accessing the sections 1906. The conversion system 108 creates the collaborative platform 1912 based on the sections 1906 and the associated configurations 1910.

In some implementations of the present disclosure, the conversion system 108 inputs the sections 1906 of the generated collaborative platform 1912 along with the actions, the process management levels defined by the entity, and the template to the second sections generation model 1914 using techniques such as, NER, POS tagging, and dependency parsing. The second sections generation model 1914 generates the refined sections 1916. The conversation system 108 uses the refined sections 1916 to create the refined collaborative platform 1918.

If the conversion system 108 fails to create the collaborative platform 1912, the conversion system 108 repeats calling of the first sections generation and configurations generation module for subsequent generation of the sections 1906 and the associated configurations 1910, which may be used for subsequent creation of the collaborative platform.

A non-limiting example of the collaborative platform may include a wiki, which may be accessed for one or more of: the actions performed for the conversion, and documentation or summarization of the results, artifacts (e.g., epics, features, or the like), successful conversions, data models, data dictionaries, and/or the like, associated with the respective actions. Therefore, the collaborative platform may provide a comprehensive and configurable documentation to facilitate understanding and usage (Word, Excel) of the actions and the associated results with diagrams. The collaborative platform may further provide editable and downloadable documents with customized document formats with logos and versioning of the documents.

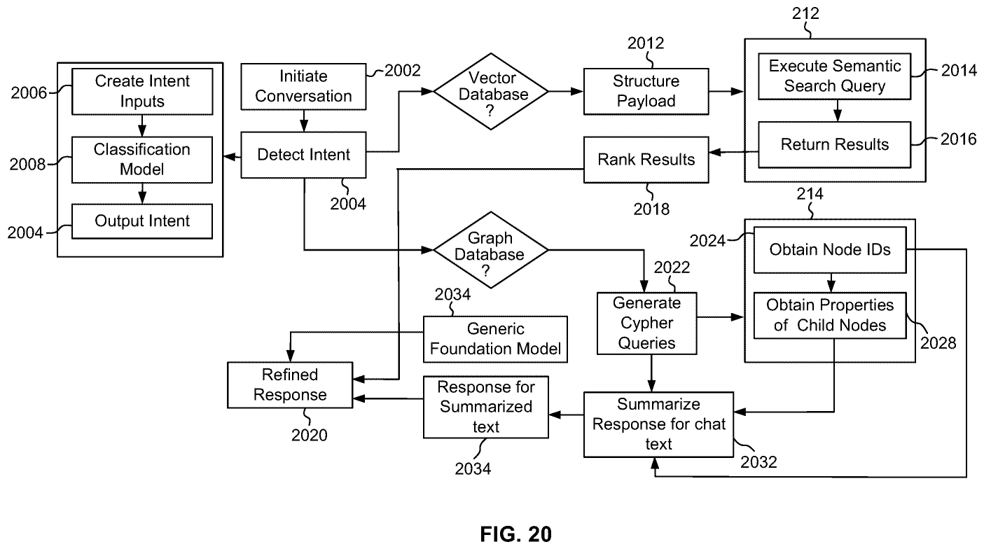

FIG. 20 depicts an example illustration of user interactions with the conversion system 108 through RAG AI framework 322, in accordance with implementations of the present disclosure.

As depicted in FIG. 20, the client device 106 initiates a conversation 2002 with the conversion system 108 through the RAG AI framework 322. In some examples, the initiated conversation 2002 may include one or more requests for accessing the results of execution of the templates/sequences of steps corresponding to the actions. Once the conversation 2002 is initiated, the conversion system 108 detects the intent/recommendation 2004 associated with the conversation 2002. For example, the conversion system 108 creates intent inputs 2006 by including the request identified in the user conversation, the action associated with the request, and the process management levels defined by the entity. The conversation system 108 calls the classification model 2008 using the intent inputs 2006 to generate the intent/recommendation 2004. In some examples, the intent/recommendation 2004 may indicate that the response for the request may be stored in the vector database 212, or the graph database 214 or the response has to be executed using a generic foundation model.

If the intent/recommendation 2004 indicates that the response for the request is stored in the vector database 212, the conversion system 108 structures a payload 2012 by including the request identified in the conversation 2002. The conversion system 108 performs an API call to the vector database 212 to execute a semantic search query 2014 on the payload 2012 and to return the results 2016 for the payload 2012. The conversion system 108 performs ranking 2018 of the results 2016 and accordingly provides the ranked results 2018 as the refined response 2020 to the client device 106.

If the intent/recommendation 2004 indicates that the response for the request is stored in the graph database 214, the conversion system 108 generate cypher queries 2022. The conversion system 108 executes a first query of the cypher queries 2022 on the graph database 214 by calling a parent route and obtains the node IDs 2024. From the node IDs 2024, parent only/both parent and child nodes of the graph may be obtained and displayed on a graph panel. The conversion system 108 executes a second query of the cypher queries 2022 on the graph database 214 to obtain node properties of the parent and child nodes 2028. Further, the conversion system 108 uses any of the foundation models 220a-220n to generate a summary response 2032 based on the node properties of the parent and child nodes 2028. The summary response 2032 may be in a text/chat text format. The conversion system 108 may access the response 2034 for the summary response 2032 from the worker pod. The response 2034 may be refined and the refined response 2020 may be provided to the client device 106.

If the intent/recommendation 2004 indicates that the response has to be executed using a generic foundation model, the conversion system 108 generates the response 2034 for the request using the generic foundation model from the foundation models 220a-220n. The response 2034 may be refined and the refined response 2020 may be provided to the client device 106.

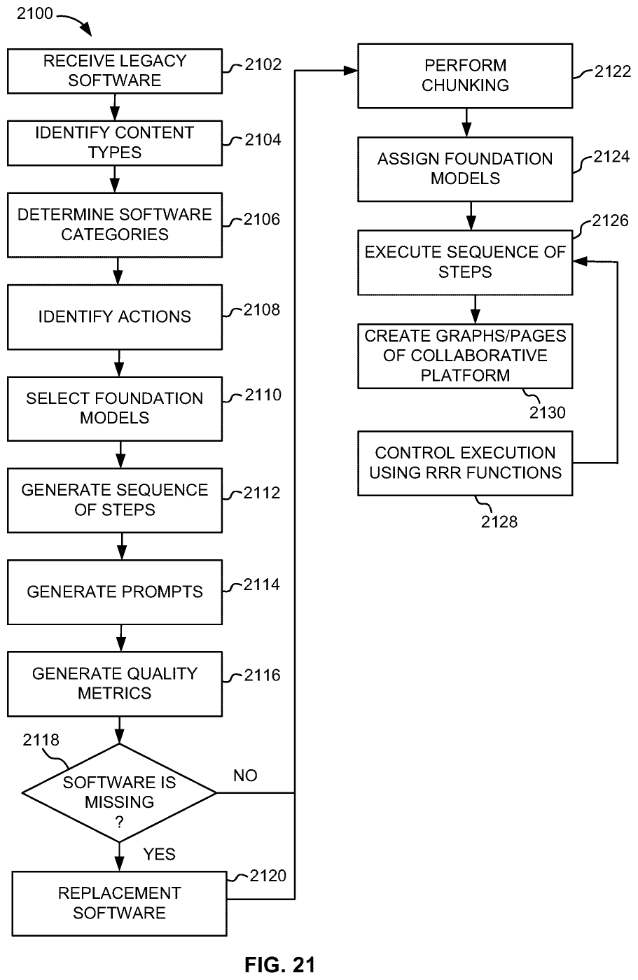

FIG. 21 is a flow diagram that presents an example computer-implemented method 2100 for converting the legacy software into the modern software, in accordance with implementations of the present disclosure. In some implementations, the method 2100 may be executed by the processor 224 of the conversion system 108, as described in relation to FIGS. 2-20.

At step 2102, the method 2100 includes receiving the legacy software and any supporting content for the conversion. The legacy software may be built in the legacy software (e.g., COBOL, PACAL, older Java version, Angular, and/or the like) and include multiple files/codes. At step 2104, the method 2100 includes first identifying the content types within the legacy software and the supporting content. Examples of the content types may include any of software code, images, non-software text, and/or audio. At step 2106, the method 2100 includes first determining the software categories for the legacy software and the supporting content. Examples of the software categories may include legacy language code, Infrastructure/Dev-ops as code, a UI code, and/or images.

At step 2108, the method 2100 includes second identifying actions to be taken for the determined software categories. Identifying the actions is described in detail in conjunction with FIGS. 4 and 5. At step 2110, the method 2100 includes first selecting foundation models 220a-220n. The foundation models 220a-220n are selected based on the identified content types and actions, to support the conversion. Selecting the foundation models are described in detail in conjunction with FIGS. 4 and 6.

At step 2112, the method 2100 includes first generating the sequence of steps/template for each of the actions to convert the legacy software into the modern software. The sequence of steps includes the foundation model steps and the non-foundation model steps. Generating the sequence of steps is described in detail in conjunction with FIGS. 4 and 7A-7B.

At step 2114, the method 2100 includes generating the prompts. The prompts may be generated for the foundation model steps in the sequence of steps. Generating the prompts is described in detail in conjunction with FIGS. 4 and 8. At step 2116, the method 2100 includes generating the quality metrics for the actions/sequence of steps. The quality metrics of the actions may be used for evaluating/measuring performance of the results of execution of the sequence of steps corresponding to the respective actions. Generation of the quality metrics for the actions is described in detail in conjunction with FIGS. 4 and 10.

At step 2118, the method 2100 further includes second determining if any necessary software to execute the sequence of steps is missing. If any necessary software is missing, at step 2120, method 2100 includes generating the replacement software, for example, necessary API calls. Missing software can be generated from scratch, obtained from another source, and/or a combination thereof. If the necessary software is not missing, the method 2100 performs step 2122.

At step 2122, the method 2100 includes performing the chunking. In some examples, the method includes third determining, based on the size of the legacy software, whether the legacy software requires chunking before executing. In response to the positive result of the third determining, the method 2100 includes second selecting the chunking methodology appropriate for the legacy software. In accordance with the selected methodology, the method 2100 includes separating/dividing the portion of the legacy software into the chunks.

Upon performing the chunking, at step 2124, the method 2100 includes assigning the foundation models from the selected foundation models 220a-220n for the foundation model steps in the sequence of steps corresponding to the action. At step 2126, the method 2100 includes executing the sequence of steps for each of the actions to generate the modern software.

Executing the sequence of steps involve executing the sequence of steps on the multiple chunks using the assigned foundation models. Performing the chunking, assigning the foundation models, and executing the sequence of steps on the multiple chunks (e.g., processing of the chunks) are described in detail in conjunction with FIGS. 4, 12, 13A-13E, 14A-14D, and 15, therefore repeated description is omitted herein for sake of brevity.

Further, at step 2128, the method 2100 includes controlling execution of the sequence of steps (the foundation model steps) by performing the RRR functions. Controlling execution of the sequence of steps may include evaluating/measuring performance of the results of execution of the sequence of steps using the generated quality metrics and accordingly applying the RRR functions to derive the results with high quality. The RRR functions are described in detail in conjunction with FIGS. 4 and 17.

After execution of the sequence of steps, at step 2130, the method 2100 includes creating the graphs and/or the collaborative platform, for example, wiki, for the results of execution of the sequence of steps corresponding to the actions. Creating the graphs and the collaborative platform are described in detail in conjunction with FIGS. 4, 18, and 19.

Implementations of the present disclosure provide technical solutions to multiple technical problems that arise in the context of traditional methods for converting the legacy software into the modern software. With the proposed methodology, an entire new piece of modern software is automatically created. The modern software provides the functionality of the legacy software and operates/functions entirely on the modern system, where the legacy software was not. The modern software generated with the proposed methodology further emulates the functionality of the legacy software and retains data from the legacy software, thereby eliminating the problem of purchasing newer replacement software with different functionality and loss of historical data. Further, with the proposed methodology, the conversion of the legacy software into the modern software is performed far more quickly and at lower expense than custom recreation of the legacy software from a scratch by manual programmers.

Implementations of the present disclosure further:
Enhance resource utilization: With the proposed methodology, the foundation models are dynamically selected and assigned for the foundation mode steps by performing a trade-off between cost, time, accuracy, speed, and/or the like. Therefore, the proposed methodology enhances/optimizes resource utilization (e.g., CPU, GPU, memory utilization) while improving efficiency of the conversion system.
Enhance TPM efficiency: Through the dynamic selection and assignment of the foundation models, the proposed methodology enhances the TPM efficiency by a reducing a need for additional deployments and improving system scalability.
Automate Optimization: The proposed methodology automates optimization of the conversion process, while simplifying the management of computational resources and reducing a burden on system administrators.
Provide Adaptive Performance: The modern software generated using the proposed methodology adapts its performance based on real-time task demands, ensuring consistent and efficient operation across varying workloads.

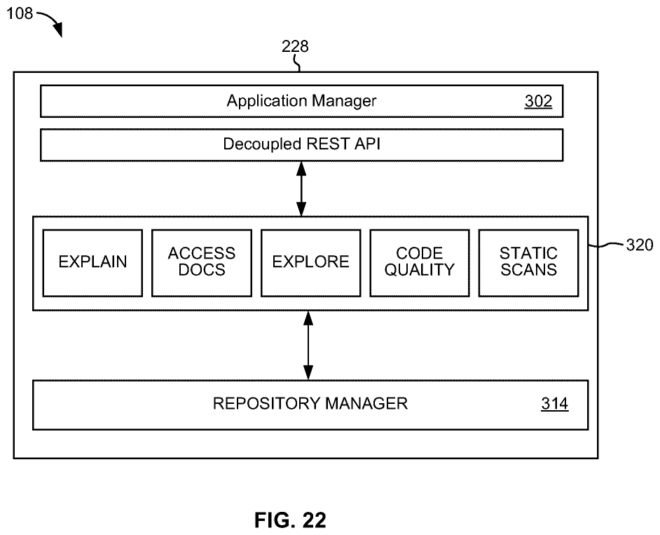

FIG. 22 depicts an example illustration of an application architecture of the conversion system 108, in accordance with implementations of the present disclosure.

As depicted in FIG. 22, with the down-streamer 320, the user associated with the client device 106 may access explanations of the results corresponding to the actions and the associated graphs, initiate a conversation with the application manager 302 (e.g., including k-bot and chatbot) for accessing documentation/test cases up-to-date and in synchronization with the evolving code base, conduct regulatory compliance checks/code quality scans to ensure adherence to standards by making the conversion comply with regulations and industry specifications, conduct low cost, shift left of security audits and identify potential vulnerabilities in the files of the legacy software before those can be exploited.

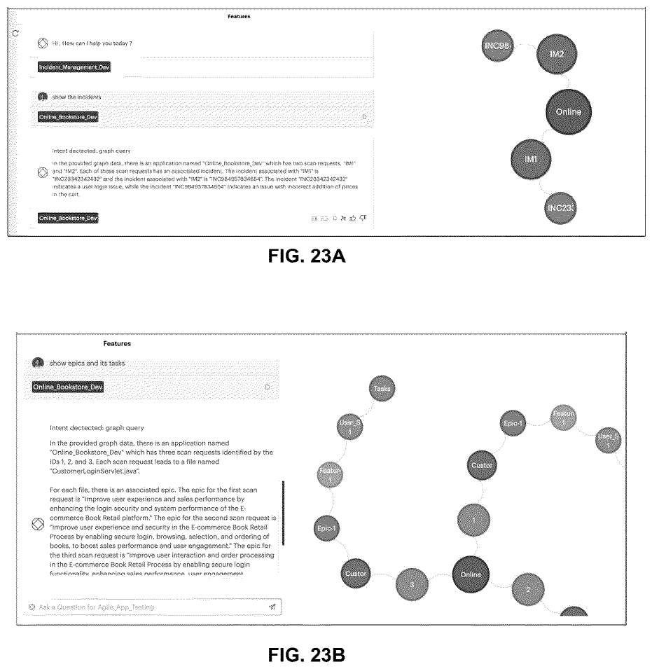

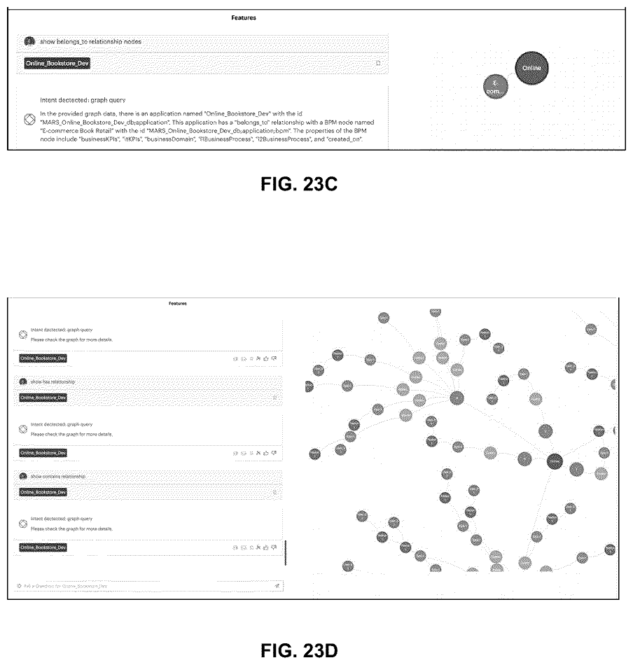

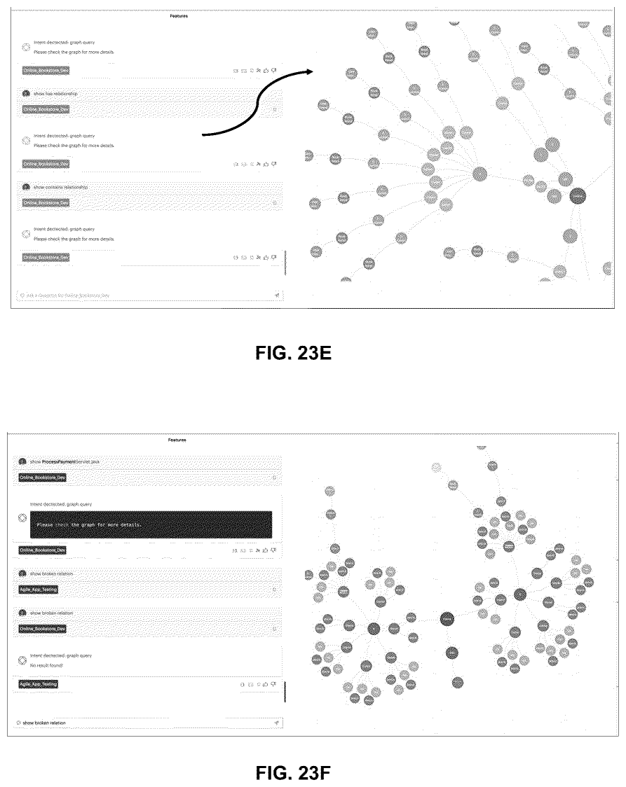

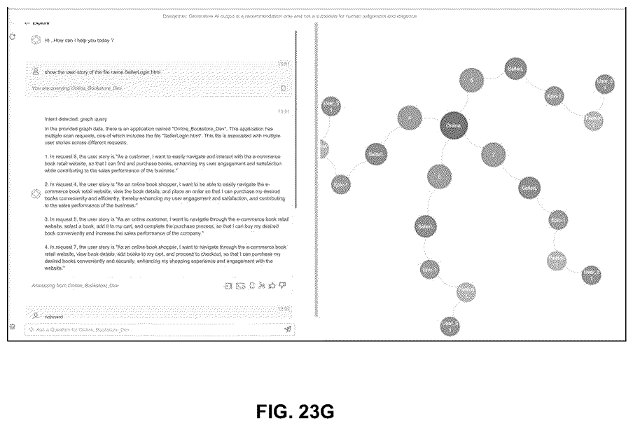

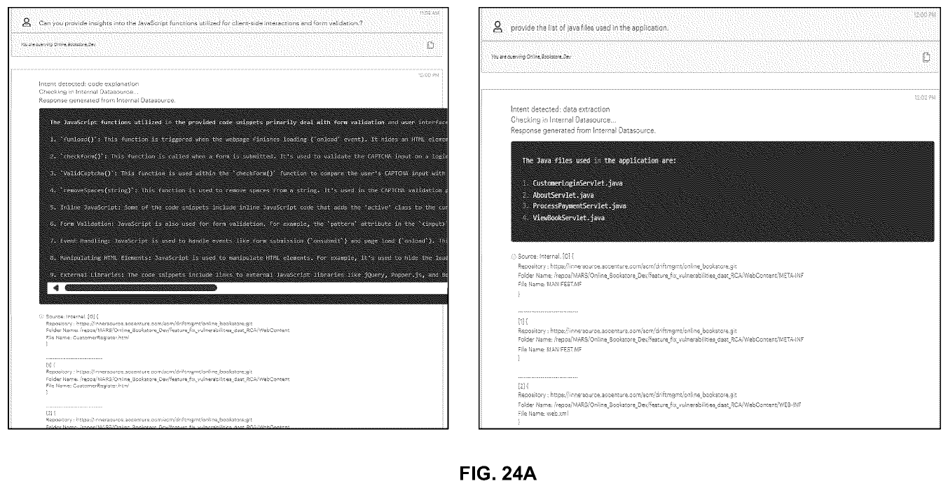

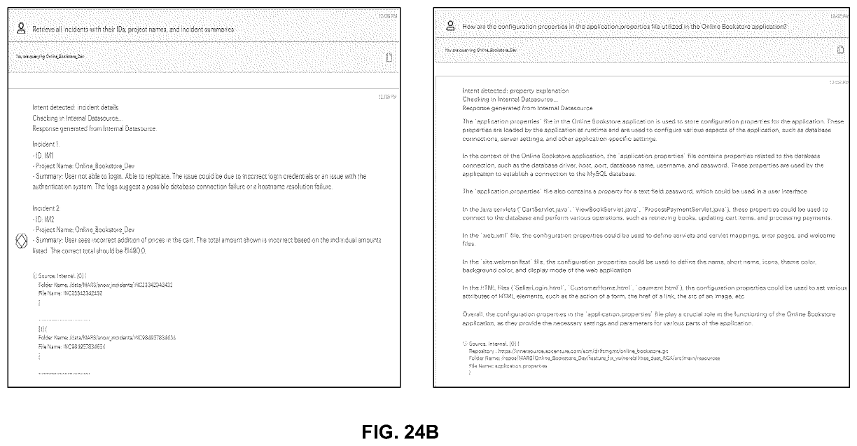

FIGS. 23A-23G and 24A-24B depict exemplary illustrations of providing multi-modal responses for the requests, in accordance with embodiments of the present disclosure.

FIGS. 23A-23G depict providing responses to requests from the client device 106 in a form of graphs. For example, as depicted in FIGS. 23A, 23B, and 23G, the graphs may provide information about incidents, artifacts such as epics and tasks/actions, user stories/conversion information for a specific seller, respectively. In addition, as depicted in FIGS. 23C-23H, more details/additional information of the graph may be provided to the client device 106.

FIGS. 24A and 24B depict providing responses to requests from the client device 106 in a textual format. The response may include insights into the codes/files of the legacy software, incidents and the configuration information related to the application to the client device 106, and/or the like.

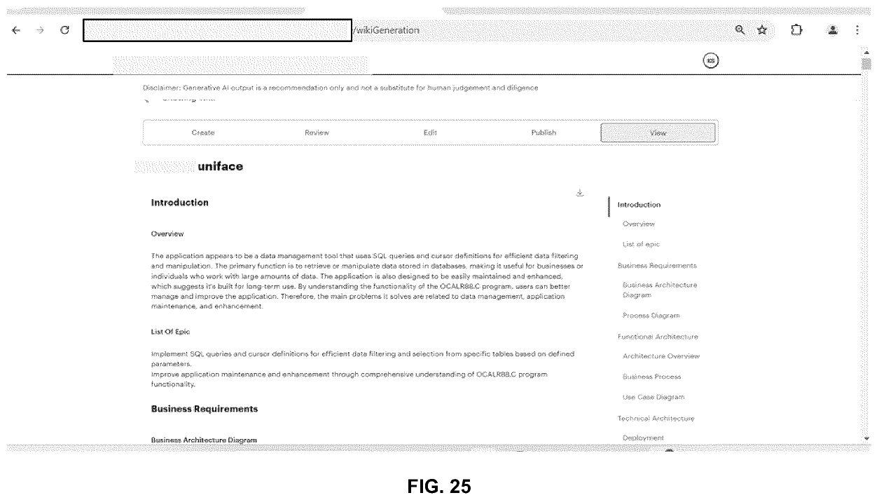

FIG. 25 depicts an example illustration of a page of the collaborative platform, in accordance with implementations of the present disclosure. The page may provide information related to an application built in Uniface language.

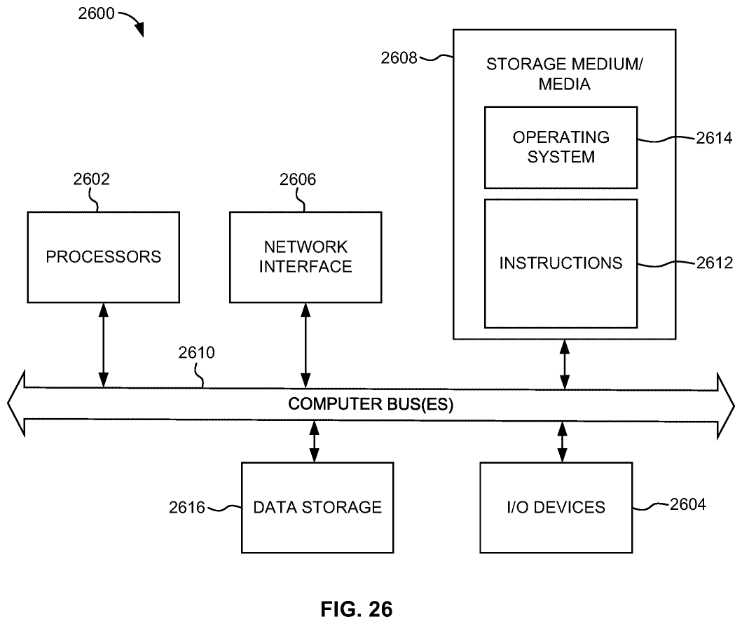

FIG. 26 illustrates a computer system 2600 that may be used to implement the computer-implemented method 2100 as described in relation with FIG. 21. More particularly, computing machines such as desktops, laptops, smartphones, tablets, and wearables which may be used to convert the legacy software into the modern software and that may have the structure of the computer system 2600. The computer system 2600 may include additional components not shown and that some of the process components described may be removed and/or modified. In another example, the computer system 2600 may be deployed on external-cloud platforms such as cloud, internal corporate cloud computing clusters, organizational computing resources, and/or the like.

The computer system 2600 includes processor(s) 2602, such as a central processing unit, ASIC or another type of processing circuit, input/output devices 2604, such as a display, mouse keyboard, etc., a network interface 2606, such as a Local Area Network (LAN), a wireless 802.11x LAN, a 3G or 4G mobile WAN or a WiMax WAN, and a computer-readable medium 2608. Each of these components may be operatively coupled to a bus 2610. The computer-readable medium 2608 may be any suitable medium that participates in providing instructions programmed to cooperate with the processor(s) 2602 to perform the computer-implemented method 2100. For example, the computer-readable medium 2608 may be non-transitory or non-volatile medium, such as a magnetic disk or solid-state non-volatile memory or volatile medium such as RAM. The instructions or modules stored on the computer-readable medium 2608 may include machine-readable instructions 2612 executed by the processor(s) 2602 that cause the processor(s) 2602 to perform the method 2100 and functions of the conversion system 108.

The method 2100 may be implemented as software stored on a non-transitory processor-readable medium and executed by the processors 2602. For example, the computer-readable medium 2608 may store an operating system 2614, such as MAC OS, MS WINDOWS, UNIX, or LINUX, and code for implementation of the method 2100. The operating system 2614 may be multi-user, multiprocessing, multitasking, multithreading, real-time, and the like. For example, during runtime, the operating system 2614 is running and the code for implementation of the method 2100 is executed by the processor(s) 2602.

The computer system 2600 may include a data storage 2616, which may include non-volatile data storage. The data storage 2616 stores any data used or generated by the method 2100.

The network interface 2606 connects the computer system 2600 to internal systems for example, via a LAN. Also, the network interface 2606 may connect the computer system 2600 to the Internet. For example, the computer system 2600 may connect to web browsers and other external applications and systems via the network interface 2606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for converting legacy software into modern software, comprising:
receiving the legacy software and any supporting content for conversion;
first identifying content types within the legacy software and the supporting content;
first determining one or more software categories for the legacy software and the supporting content;
second identifying actions to be taken for the determined software categories;
first selecting a plurality of foundation models, based on the identified content types and the identified actions, to support the conversion;
first generating a sequence of steps for each of the actions to convert the legacy software into the modern software, the sequence of steps including foundation model steps and non-foundation model steps;
second determining if any necessary software to execute the steps is missing;
second generating, in response to a positive result of the second determining, replacement software for the missing software; and
executing the sequence of steps for each of the actions to generate the modern software.

2. The method of claim 1 wherein the content types include any of software code, images, non-software text, and/or audio.

3. The method of claim 1, wherein the software categories include any of legacy language code, Infrastructure as Code, Dev-Ops as code, user interface code, and/or images.

4. The method of claim 1, further comprising:
third determining, based on a size of the legacy software, whether the legacy software requires chunking before executing;
second selecting, in response to a positive result of the third determining, at least one chunking methodology appropriate for the legacy software; and
separating at least a portion of the legacy software into chunks per the selected at least one chunking methodology;
wherein the executing the sequence of steps comprises executing the sequence of steps on the chunks.

5. The method of claim 1, wherein the second selecting at least one chunking methodology comprises selecting:
logical chunking for object oriented programming;
token based chunking for non-object oriented programming;
file size based chunking for audio files;
duration length based chunking for video files; and
image-token based chunking for image files.

6. The method of claim 1, wherein the generating the sequence of steps further comprises:
obtaining from a global template repository, an existing series of steps appropriate for the conversion; and/or
submitting the software categories and at least some of the received supporting content to a template generation model and receiving in response at least some of the steps for each of the actions from the template generation model including the foundation model steps and the non-foundation model steps.

7. The method of claim 6, further comprising:
generating prompts and associated roles and parameters for the foundation model steps included in the sequence of steps generated for each of the actions; and
storing, for each of the actions, the sequence of steps including the foundation model steps, the non-foundation model steps, and the prompts and the associated roles and parameters for the foundation model steps, as a template in the global template repository.

8. The method of claim 1, further comprising:
determining, based on the identified actions, corresponding quality metrics to measure performance of the foundation model steps; and
the first generating the sequence of steps comprises selecting steps that satisfy the corresponding metrics.

9. The method of claim 1, wherein executing the sequence of steps for each of the actions to generate the modern software comprises:
scheduling an order of performing the actions;
mapping chunks corresponding to at least a portion of the legacy software for each of the actions;
mapping the sequence of steps for each of the actions;
assigning, from the selected plurality of foundation models, at least one foundation model for the foundation model steps in the sequence of steps; and
executing, for each of the actions, the sequence of steps on the respective chunks using the assigned at least one foundation model.

10. The method of claim 9, wherein assigning, from the selected plurality of foundation models, the at least one foundation model for the sequence of steps comprises assigning the at least one foundation model based on one or more of:
a model reputation score of each of the selected plurality of foundation models;
features of each of the selected plurality of foundation models;
budget and time parameters associated with the sequence of steps; and
an action associated with the sequence of steps.

11. The method of claim 9, further comprising:
deriving quality scores for the results of execution of the foundation model steps included in the sequence of steps by measuring performance of results of execution of the foundation model steps using a respectively determined quality metrics;
determining if the quality scores fall below a predetermined threshold score;
determining, in response to determining that the quality scores fall below the predetermined threshold score, to initiate a retry function, wherein the retry function includes tuning hyperparameters of at least one foundation model assigned for the foundation model steps, retrying executions of the foundation model steps using the tuned at least one foundation model, and deriving the quality scores for the retried executions; and
performing the retry function iteratively till the quality scores fall above the predetermined threshold score or a number of retry counts is greater than a predetermined retry count.

12. The method of claim 11, further comprising:
determining, in response to determining that the quality scores fall below the predetermined threshold score and the number of retry counts is greater than the predetermined retry count, to initiate a rephrase function, wherein the rephrase function includes rephrasing prompts generated for the foundation model steps, retrying executions of the foundation model steps using rephrased prompts, and deriving the quality scores for the retried executions; and
performing the rephrase function iteratively till the quality scores fall above the predetermined threshold score or a number of rephrase counts is greater than a predetermined rephrase count.

13. The method of claim 12, further comprising:
performing, in response to determining that the quality scores fall below the predetermined threshold score after performing the retry function and the rephrase function, a fine-tuning of the at least one foundation model assigned for the foundation model steps; and
initiating performing of the retry function following the rephrase function, till the quality scores fall above the predetermined threshold score.

14. The method of claim 1, further comprising:
generating graphs for visualizing the results of execution of the sequence of steps for each of the actions; and
creating a collaborative platform for accessing the results of execution of the sequence of steps.

15. A non-transitory computer readable media storing instructions programmed to cooperate with electronic computer hardware in combination with software to perform operations for converting legacy software into modern software, the operations comprising:
receiving the legacy software and any supporting content for conversion;
first identifying content types within the legacy software and the supporting content;
first determining one or more software categories for the legacy software and the supporting content;
second identifying actions to be taken for the determined software categories;
first selecting a plurality of foundation models, based on the identified content types and the identified actions, to support the conversion;
first generating a sequence of steps for each of the actions to convert the legacy software into the modern software, the sequence of steps including foundation model steps and non-foundation model steps;
second determining if any necessary software to execute the steps is missing;
second generating, in response to a positive result of the second determining, replacement software for the missing software; and
executing the sequence of steps for each of the actions to generate the modern software.

16. The non-transitory computer readable media of claim 15, the operations further comprising:
third determining, based on a size of the legacy software, whether the legacy software requires chunking before executing;
second selecting, in response to a positive result of the third determining, at least one chunking methodology appropriate for the legacy software; and
separating at least a portion of the legacy software into chunks per the selected at least one chunking methodology;
wherein the executing the sequence of steps comprises executing the sequence of steps on the chunks.

17. The non-transitory computer readable media of claim 15, wherein the generating a sequence of steps further comprises:
obtaining from a global template repository, an existing series of steps appropriate for the conversion; and/or
submitting the software categories and at least some of the received supporting content to a template generation model and receiving in response at least some of the steps for each of the actions from the template generation model including the foundation model steps and the non-foundation model steps.

18. A system, comprising:
a processor;
a non-transitory computer readable memory storing instructions programmed to cooperate with the processor to perform operations for converting legacy software into modern software, the operations comprising:
receiving the legacy software and any supporting content for conversion;
first identifying content types within the legacy software and the supporting content;
first determining one or more software categories for the legacy software and the supporting content;
second identifying actions to be taken for the determined software categories;
first selecting a plurality of foundation models, based on the identified content types and the identified actions, to support the conversion;
first generating a sequence of steps for each of the actions to convert the legacy software into the modern software, the sequence of steps including foundation model steps and non-foundation model steps;
second determining if any necessary software to execute the steps is missing;
second generating, in response to a positive result of the second determining, replacement software for the missing software; and
executing the sequence of steps for each of the actions to generate the modern software.

19. The system of claim 18, the operations further comprising:
third determining, based on a size of the legacy software, whether the legacy software requires chunking before executing;
second selecting, in response to a positive result of the third determining, at least one chunking methodology appropriate for the legacy software; and
separating at least a portion of the legacy software into chunks per the selected at least one chunking methodology;
wherein the executing the sequence of steps comprises executing the sequence of steps on the chunks.

20. The system of claim 19, wherein the generating a sequence of steps further comprises:
obtaining from a global template repository, an existing series of steps appropriate for the conversion; and/or
submitting the software categories and at least some of the received supporting content to a template generation model and receiving in response at least some of the steps for each of the actions from the template generation model including the foundation model steps and the non-foundation model steps.
